(19) United States
(12) Patent Application Publication
(10) Pub. No.: US 2022/0376856 A1
(43) Pub. Date: Nov. 24, 2022

(54) DOWNLINK AND UPLINK BEAM MANAGEMENT ENHANCEMENTS FOR FULL DUPLEX

(71) Applicant: QUALCOMM Incorporated, San Diego, CA (US)

(72) Inventors: Qiaoyu LI, Beijing (CN); Min HUANG, Beijing (CN); Yu ZHANG, Beijing (CN); Chao WEI, Beijing (CN); Liangming WU, Beijing (CN); Chenxi HAO, Beijing (CN); Yuwei REN, Beijing (CN); Hao XU, Beijing (CN); Wanshi CHEN, San Diego, CA (US)

(21) Appl. No.: 17/607,509

(22) PCT Filed: May 29, 2020
(86) PCT No.: PCT/CN2020/093103

§ 371 Date: Oct. 29, 2021

(30) Foreign Application Priority Data
May 31, 2019 (CN) PCT/CN2019/089600
May 31, 2019 (CN) PCT/CN2019/089632

(51) Int. Cl. H04L 5/00; H04W 24/08; H04L 5/16

(52) U.S. Cl. CPC H04L 5/0048; H04W 24/08; H04L 5/16

(57) ABSTRACT

Certain aspects of the present disclosure provide techniques for downlink and/or uplink beam management for full-duplex communications. An example method generally includes receiving, from a wireless node, a RS resource configuration indicating interference RS resources associated with interference reference signal transmissions; monitoring interference RSs via the interference RS resources; for each of the interference RS resources, determining a reception beam based at least in part on the monitored more interference RSs corresponding to the interference RS resources; receiving control signaling, from the second wireless node, indicating QCL information, which also indicates to either refrain from using any monitored interference RS resource in determining spatial reception parameters or identify at least one monitored interference RS resource to use in determining the spatial reception parameters; and determining the spatial reception parameters in accordance with the control signaling.

### CROSS-REFERENCE TO RELATED APPLICATIONS

The present International Application claims benefit of and priority to International Application No. PCT/CN2019/089600, filed May 31, 2019, and International Application No. PCT/CN2019/089632, filed May 31, 2019, each of which is herein incorporated by reference in its entirety for all applicable purposes.

### BACKGROUND

### Field of the Disclosure

Aspects of the present disclosure relate to wireless communications, and more particularly, to techniques for downlink and/or uplink beam management for full-duplex communications.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipment (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, next generation NodeB (gNB or gNodeB), TRP, etc.). A BS or DU may communicate with a set of UEs on downlink channels (e.g., for transmissions from a BS or DU to a UE) and uplink channels (e.g., for transmissions from a UE to a BS or DU).

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include downlink and/or uplink beam management enhancements for full-duplex wireless communications.

Certain aspects provide a method for wireless communication. The method generally includes receiving, from a second wireless node, a reference signal resource configuration indicating one or more interference reference signal (RS) resources associated with interference reference signal transmissions; monitoring one or more interference RSs via the one or more interference RS resources; for each of the one or more interference RS resources, determining at least one reception beam based at least in part on each of the monitored one or more interference RSs corresponding to at least one of the one or more interference RS resources; receiving control signaling, from the second wireless node, indicating quasi-colocation (QCL) information, wherein the QCL information indicates to either refrain from using any monitored interference RS resource in determining spatial reception parameters or identify at least one monitored interference RS resource to use in determining the spatial reception parameters; and determining the spatial reception parameters in accordance with the control signaling.

Certain aspects provide a method for wireless communication. The method generally includes receiving, from a second wireless node, a reference signal resource configuration indicating one or more interference reference signal (RS) resource groups associated with interference reference signal transmissions, wherein each of the interference RS resource groups comprises one or more interference RS resources; monitoring one or more interference RSs via the one or more interference RS resources corresponding to the one or more interference RS resource groups; for each of the interference RS resource groups, determining at least one reception beam based at least in part on each of the monitored one or more interference RS resources corresponding to at least one of the one or more interference RS resource groups; receiving control signaling, from the second wireless node, indicating quasi-colocation (QCL) information, wherein the QCL information indicates either to refrain from using any monitored interference RS resource group in determining spatial reception parameters or identify at least one monitored interference RS resource group to use in determining the spatial reception parameters; and determining the spatial reception parameters in accordance with the control signaling.

Certain aspects provide a method for wireless communication. The method generally includes transmitting, to a first wireless node, a reference signal resource configuration indicating one or more interference reference signal (RS) resources associated with interference reference signal transmissions; receiving, from the first wireless node, a beam interference report indicating one or more interference levels of a reception beam at the first wireless node based at least in part on the one or more interference RS resources; transmitting control signaling, to the first wireless node, indicating quasi-colocation (QCL) information, wherein the QCL information indicates to either refrain from using any interference RS resource in the reference signal resource configuration in determining spatial reception parameters or identify at least one interference RS resource in the reference signal resource configuration to use in determining the spatial reception parameters; and scheduling full duplex communications involving the first wireless node and one or more other wireless nodes based at least in part on the beam interference report.

Certain aspects provide a method for wireless communication. The method generally includes transmitting, to a first wireless node, a reference signal resource configuration indicating one or more interference reference signal (RS) resource groups associated with interference RS transmissions, wherein each of the interference RS resource groups comprises one or more interference RS resources; receiving, from the first wireless node, a beam interference report indicating one or more interference levels of a reception beam at the first wireless node based at least in part on the one or more interference RS resource groups; transmitting control signaling, to the first wireless node, indicating quasi-colocation (QCL) information, wherein the QCL information indicates either to refrain from using any monitored interference RS resource group in the reference signal resource configuration in determining spatial reception parameters or identify at least one monitored interference RS resource group in the reference signal resource configuration to use in determining the spatial reception parameters; and scheduling full duplex communications involving the first wireless node and one or more other wireless nodes based at least in part on the beam interference report.

Certain aspects provide an apparatus for wireless communication. The apparatus generally includes a receiver configured to: receive, from a wireless node, a reference signal resource configuration indicating one or more first interference reference signal (RS) resources associated with interference reference signal transmissions or one or more interference RS resource groups associated with the interference reference signal transmissions, wherein each of the interference RS resource groups comprises one or more second interference RS resources, and receive control signaling, from the wireless node, indicating quasi-colocation (QCL) information, wherein the QCL information indicates to either refrain from using any monitored interference RS resource in the reference signal resource configuration in determining spatial reception parameters or identify at least one monitored interference RS resource in the reference signal resource configuration to use in determining the spatial reception parameters. The apparatus also includes a processing system configured to: monitor one or more interference RSs via the one or more first interference RS resources or the one or more second interference RS resources, determine, for each of the one or more first interference RS resources or each of the interference RS resource groups, at least one reception beam based at least in part on each of the monitored one or more interference RSs corresponding to at least one of the one or more first interference RS resources or the one or more second interference RS resources, and determine the spatial reception parameters in accordance with the control signaling.

Certain aspects provide an apparatus for wireless communication. The apparatus generally includes a receiver configured to receive, from a wireless node, a reference signal (RS) resource configuration indicating one or more interference RS resources or one or more interference RS resource groups. The apparatus also includes a processing system configured to monitor one or more interference RSs for each of the one or more interference RS resources or for each of the one or more interference RS resource groups, wherein the one or more interference RSs for each of the one or more interference RS resources or for each of the one or more interference RS resource groups are associated with a plurality of transmission beams, measure, for the one or more interference RSs of each of the one or more interference RS resources or each of the one or more interference RS resource groups, interference associated with at least one of the plurality of beams, and generate an interference report based on the measurement. The apparatus further includes a transmitter configured to transmit the interference report to the wireless node.

Certain aspects provide an apparatus for wireless communication. The apparatus generally includes a receiver configured to receive, from a wireless node, a reference signal (RS) resource configuration indicating one or more interference RS resources. The apparatus also includes a processing system configured to: monitor for one or more interference RSs via the one or more interference RS resources; determine, for each of the one or more interference RS resources, a reception beam based on the one or more interference RSs of the one or more interference RS resources, wherein the reception beam is one of a plurality of reception beams used to receive the one or more interference RSs, the reception beam having the lowest reception power of the plurality of reception beams; and select a transmission beam corresponding to the reception beam. The apparatus further includes a transmitter configured to transmit signaling to the wireless node via the transmission beam.

Certain aspects provide an apparatus for wireless communication. The apparatus generally includes a receiver configured to receive, from a wireless node, a reference signal (RS) resource configuration indicating one or more full-duplex interference RS resources and one or more half-duplex interference RS resources. The apparatus also includes a transmitter configured to transmit one or more interference RSs for each of the one or more full-duplex interference RS resources and the one or more half-duplex interference resources. The receiver is further configured to receive, from the wireless node, an indication of quasi-colocation (QCL) information after the transmission of the one or more interference RSs, the QCL information indicating first spatial relation information to use for transmissions via the one or more full-duplex interference resources and second spatial relation information to use for transmission via one or more half-duplex interference resources. The transmitter is further configured to transmit signaling to the wireless node in accordance with the QCL information.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example base station (BS) and user equipment (UE), in accordance with certain aspects of the present disclosure.

FIG. 3 illustrates an example full-duplex wireless communication system, in accordance with certain aspects of the present disclosure.

FIG. 4 illustrates an example full-duplex wireless communication system, where the UE monitors reference signal (RS) resources, in accordance with certain aspects of the present disclosure.

FIG. 5 illustrates an example full-duplex wireless communication system, where the UE monitors reference signal resource groups, in accordance with certain aspects of the present disclosure

FIG. 6 illustrates an example full-duplex wireless communication system where the BS provides quasi colocation (QCL) information with or without corresponding interference RSs, in accordance with certain aspects of the present disclosure.

FIG. 7 is a signaling flow diagram illustrating example operations for performing downlink beam management in a full-duplex setting, in accordance with certain aspects of the present disclosure.

FIG. 8 is a flow diagram illustrating example operations for downlink beam management based on interference RS resources, in accordance with certain aspects of the present disclosure.

FIG. 9 is a flow diagram illustrating example operations for scheduling full-duplex communications based on interference reported at the interference RS resource level, in accordance with certain aspects of the present disclosure.

FIG. 10 is a flow diagram illustrating example operations for downlink beam management based on interference RS resource groups, in accordance with certain aspects of the present disclosure.

FIG. 11 is a flow diagram illustrating example operations for scheduling full-duplex communications based on interference reported at the interference RS resource group level, in accordance with certain aspects of the present disclosure.

FIG. 12 is an example full-duplex wireless communication system for uplink beam refinement using beam sweeping, in accordance with certain aspects of the present disclosure.

FIG. 13 is a signaling flow diagram illustrating example operations for beam management, in accordance with certain aspects of the present disclosure.

FIG. 14 is a flow diagram illustrating example operations for wireless communication by a BS, in accordance with certain aspects of the present disclosure.

FIG. 15 is a flow diagram illustrating example operations for wireless communication by a UE, in accordance with certain aspects of the present disclosure.

FIG. 16 is an example full-duplex wireless communication system for uplink beam refinement using beam-sweeping and interference RS resource groups, in accordance with certain aspects of the present disclosure.

FIG. 17 is a flow diagram illustrating example operations for wireless communication by a BS, in accordance with certain aspects of the present disclosure.

FIG. 18 is a flow diagram illustrating example operations for wireless communication by a UE, in accordance with certain aspects of the present disclosure.

FIG. 19 is a signaling flow diagram illustrating example operations for beam management using beam correspondence, in accordance with certain aspects of the present disclosure.

FIG. 20 is a flow diagram illustrating example operations for wireless communication by a UE, in accordance with certain aspects of the present disclosure.

FIG. 21 is a flow diagram illustrating example operations for wireless communication by a UE, in accordance with certain aspects of the present disclosure.

FIG. 22 illustrates an example wireless communication system for integrated access and backhaul (IAB), in accordance with certain aspects of the present disclosure.

FIG. 23 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for downlink and/or uplink beam management in a full-duplex setting. For example, a UE may monitor reference signals transmitted by other UEs and determine a reception beam that reduces the interference from the reference signals, for example, while the UE is receiving downlink transmissions from a BS. Other aspects of the present disclosure relate to scheduling full-duplex communications based on an interference report generated by the UE that monitors the reference signals. Aspects of the present disclosure also relate to the BS transmitting control signaling indicating, to the UE, whether to use the determined reception for purposes of quasi-colocation (QCL) information. In aspects, the UE may also monitor reference signals transmitted by other UEs and determine an uplink transmission beam that reduces interference at other UEs during full-duplex communications.

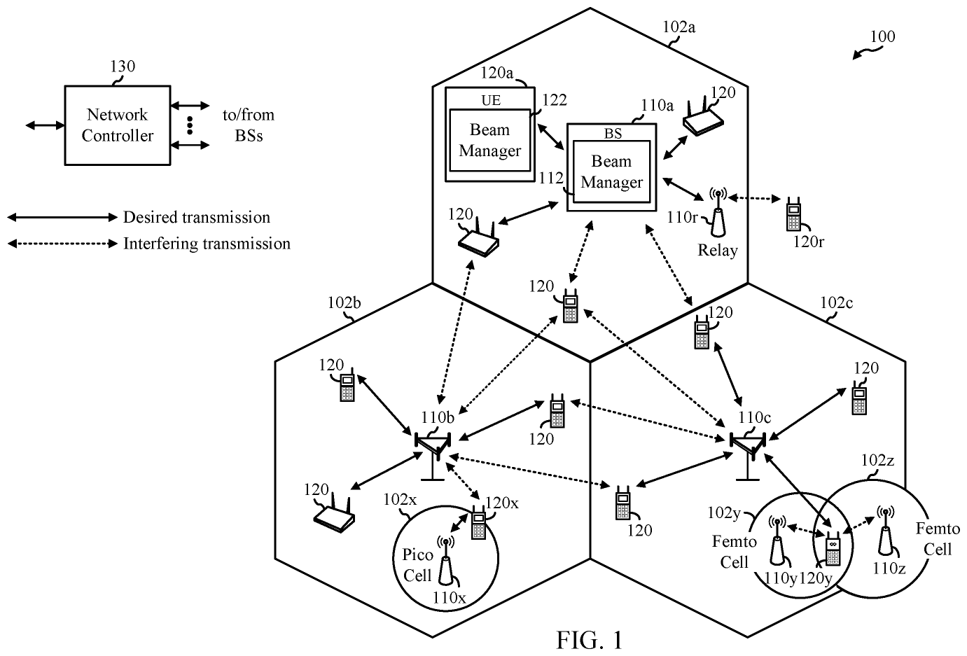

FIG. 1 illustrates an example wireless communication network 100 in which aspects of the present disclosure may be performed. The wireless communication network 100 may be an NR system (e.g., a 5G NR network). For example, as shown in FIG. 1, the UE 120a has a beam manager 122 that may be configured for determining downlink reception beams that reduce interference from other UEs during full-duplex communications and/or for determining an uplink transmission beam that reduces interference at other UEs during full-duplex communications, according to aspects described herein. The BS 110a has a beam manager 112 that may be configured for scheduling full-duplex communications based on an interference report generated by the UE 120a or other UEs, according to aspects described herein.

NR is an emerging wireless communications technology under development in conjunction with the 5G Technology Forum (5GTF). NR access (e.g., 5G NR) may support various wireless communication services, such as enhanced mobile broadband (eMBB) targeting wide bandwidth (e.g., 80 MHz or beyond), millimeter wave (mmWave) targeting high carrier frequency (e.g., 25 GHz or beyond), massive machine type communications MTC (mMTC) targeting non-backward compatible MTC techniques, and/or mission critical services targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

As illustrated in FIG. 1, the wireless communication network 100 may include a number of base stations (BSs) 110 and other network entities. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple (e.g., three) cells. Wireless communication network 100 may also include relay stations. In the example shown in FIG. 1, a relay station 110r may communicate with the BS 110a and a UE 120r in order to facilitate communication between the BS 110a and the UE 120r. A relay station may also be referred to as a relay BS, a relay, etc.

The UEs 120 (e.g., 120x, 120y, etc.) may be dispersed throughout the wireless communication network 100, and each UE may be stationary or mobile. In FIG. 1, a solid line with double arrows indicates desired transmissions between a UE and a serving BS, which is a BS designated to serve the UE on the downlink and/or uplink. A finely dashed line with double arrows indicates potentially interfering transmissions between a UE and a BS.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

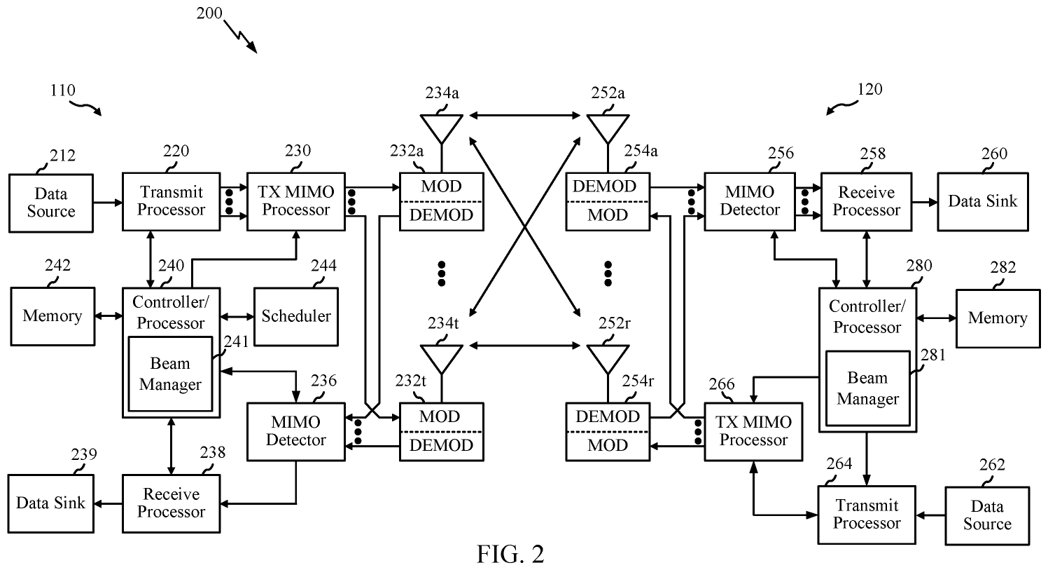

FIG. 2 illustrates example components of BS 110 and UE 120 (e.g., in the wireless communication network 100 of FIG. 1), which may be used to implement aspects of the present disclosure. For example, antennas 252, processors 266, 258, 264, and/or controller/processor 280 of the UE 120 and/or antennas 234, processors 220, 230, 238, and/or controller/processor 240 of the BS 110 may be used to perform the various techniques and methods described herein. For example, as shown in FIG. 2, the controller/processor 240 of the BS 110 has a beam manager 241 that may be configured for scheduling full-duplex communications based on an interference report generated by the UE 120a, according to aspects described herein. The controller/processor 280 of the UE 120 has a beam manager 281 that may be configured for determining downlink reception beams that reduce interference from other UEs during full-duplex communications and/or for determining an uplink transmission beam that reduces interference at other UEs during full-duplex communications, according to aspects described herein.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MTMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120, the antennas 252a-252r may receive the downlink signals from the BS 110 and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, etc.), and transmitted to the base station 110. At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The controllers/processors 240 and 280 may direct the operation at the BS 110 and the UE 120, respectively. The controller/processor 240 and/or other processors and modules at the BS 110 may perform or direct the execution of processes for the techniques described herein. The memories 242 and 282 may store data and program codes for BS 110 and UE 120, respectively. A scheduler 244 may schedule UEs for data transmission on the downlink and/or uplink

### Example Beam Management Enhancementsfor Full Duplex

In a full-duplex cell, a pair of UEs (or more), including a UE (hereinafter referred to as UE-1) receiving downlink signals (e.g., PDSCH data) and another UE (hereinafter referred to as UE-2) transmitting uplink signals (e.g., PUSCH data) may use the same frequency-time resources to communicate with a base station. In certain cases where downlink and/or uplink multi-user multiple-input and multiple-output (MU-MIMO) is deployed, there may be multiple UEs that receive downlink signals (e.g., PDSCH) and multiple UEs that transmit uplink signals (e.g., PUSCH) operating simultaneously. A BS may make pairing choices regarding which UEs may communicate simultaneously using the same frequency-time resources. There may be multiple choices of UE pairs, which may be scheduled by a BS. The BS may consider several factors when making pairing choices, such as the interference from uplink transmissions of UE-2 encountered at UE-1 during downlink reception. The BS may also consider the self-interference at the BS from the downlink transmissions to UE-1 encountered at the BS during the reception of uplink transmission from UE-2.

Certain aspects of the present disclosure relate to reducing the interference encountered at UE-1 during full-duplex communications. For example, to find the proper UE pairs with reduced interference, the BS may schedule a UE-1 to monitor interference reference signal resources (e.g., sounding reference signal (SRS) resources, channel state information reference signal (CSI-RS) resources, or any suitable reference signal resources) to allow the BS and the UEs to measure the UE-to-BS and UE-to-UE channel and interference properties during full-duplex communications. The BS may also schedule different UE-2s to transmit signals in accordance with the configured different interference RS resources, such that the UE1 may measure the interference from different UE-2s correspondingly. The UE-1 may be configured to feedback the measurement results to the BS, to help the BS further determine UE pairings, as described in more detail herein.

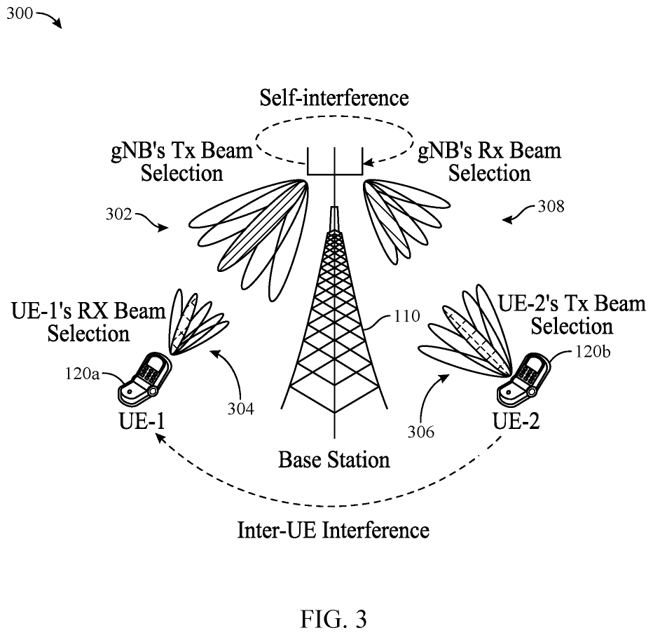

FIG. 3 illustrates an example full-duplex wireless communication system 300, in accordance with certain aspects of the present disclosure. Beam management is important for the performance of higher frequencies, as beams may be relatively thin in such scenarios to provide enough beamforming gain. Beam management is generally controlled by the BS 110. For example, in DL, the BS 110 may transmit multiple beams (e.g., beams 302) to a UE 120a (e.g., UE-1), followed by the UE 120a reporting the index of the strongest beams to be used for transmission of signals (e.g., PDSCH). The UE 120a may also determine one or more reception (Rx) beams (e.g., Rx beams 304) to be used for the reception of signals (e.g., PDSCH) from the BS 110. Similarly, a UE 120b (e.g., UE-2) may determine one or more transmission (Tx) beams (e.g., Tx beams 306) to use for transmission of signals (e.g., PUSCH) to the BS 110, and the BS may select Rx beams for reception of signals (e.g., PUSCH) from the UE 120b. In certain aspects, the Tx beams of the BS 110 may be conveyed by multiple synchronization signal blocks (SSBs) or channel state information-reference signals (CSI-RSs) to the UE 120a. For UL transmissions, the UE 120b (e.g., UE-2) may be configured by the BS 110 to apply different Tx beams to different SRS resources for BS 110 to select the strongest Tx beam to be used for UL transmissions (e.g., PUSCH), or transmit SRSs with the same Tx beam across multiple symbols for BS to refine its Rx beam.

As illustrated, in a full-duplex cell, UE 120a Rx beam and UE 120b Tx beam are not simply reliant on the BS-to-UE channel. For example, for a certain UE 120b and its corresponding Tx beam, the UE 120a may determine a Rx beam to receive downlink signals (e.g., PDSCH data) form the BS 110 such that the interference from the UE 120b may be reduced, while the downlink signals from the BS may still be decoded. Therefore, the BS-to-UE and the UE-to-UE channels (e.g., inter-UE interference) may be considered when determining the Rx beam (e.g., one of Rx beams 304) of the UE 120a. Similarly, for UE 120a, the UE 120b may determine the Tx beam to transmit uplink signals (e.g., PUSCH data), such that the interference towards the UE 120a may be reduced, while the uplink signals received by the BS may still be decoded. Therefore, the BS-to-UE and the UE-to-UE channels may also be considered when determining the Tx beam of the UE 120b. In a similar manner, when the BS determines its Rx beam, the BS may consider interference from the downlink transmission to UE 120a when receiving the uplink transmissions from the UE 120b.

### Example Downlink Beam Management Enhancementsfor Full Duplex

Certain aspects of the present disclosure provide techniques for downlink beam refinement in full-duplex communication applications. For example, UE-1 may monitor interference reference signal (RS) resources from one or more UE-2s and determine a preferred reception beam for receiving downlink transmissions from the BS while receiving interfering signals from the UE-2(s).

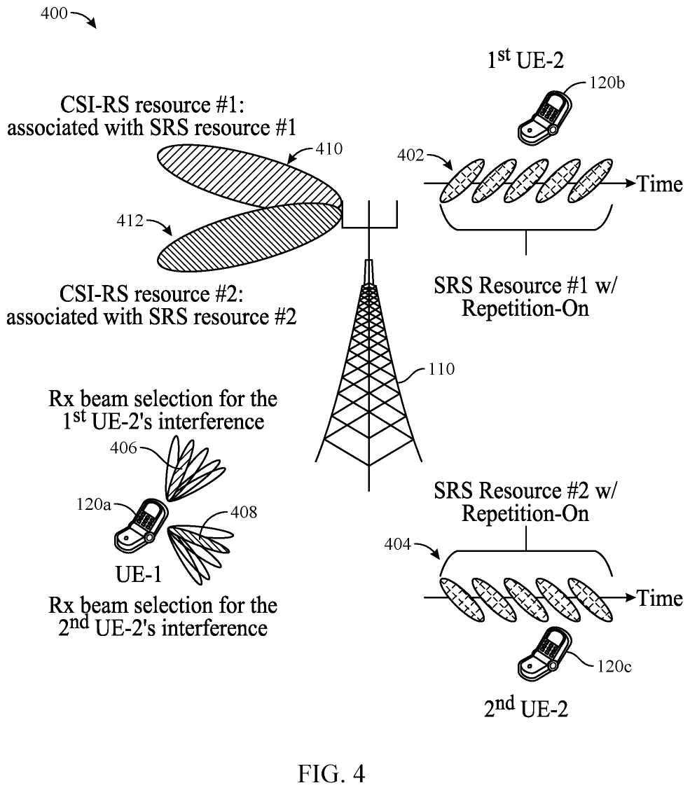

FIG. 4 illustrates an example full-duplex wireless communication system 400, where the UE 120a (e.g., UE-1) monitors reference signal resources from interfering UEs 120b and 120c (e.g., UE-2(s)), in accordance with certain aspects of the present disclosure. As shown, the UE 120a may be configured with one or more interference RS resource(s) (e.g., time and frequency resources) to monitor interference RSs 402, 404 from the UEs 120b and 120c, respectively, via uplink Tx beams. The interference RS resources may be sounding reference signal (SRS) resources or CSI-RS resources. For instance, instead of SRS based monitoring and reporting, UE 120a may be configured by the BS 110 to monitor CSI-RS resources for interference power measurements, and the BS 110 may configure UE 120b or 120c to transmit signals in accordance with the CSI-RS resources. The CSI-RS resources for interference power measurements may be separate from the CSI-RS resources transmitted by the BS for signal power measurement as further described herein.

The BS 110 may transmit, to the UE 120a, a reference signal resource configuration indicating the interference RS resources to monitor. For instance, the reference signal resource configuration may include one or more index values associated with the interference RS resource(s). The UE 120a may determine the interference RS resource(s) to monitor in accordance with the index values. The reference signal resource configuration may indicate to perform the monitoring of the one or more interference RS resources on a semi-persistent, periodic, aperiodic, or dynamic basis. The reference signal resource configuration may indicate the interference RS resources at a band or subband level of a carrier bandwidth.

Each of the interference RS resources may be set to repeat according to a repetition pattern or interval and have the same or a different number of repetitions. For instance, the reference signal resource configuration may further indicate that the interference RS resources will be transmitted with repetition enabled (e.g., “Repetition-On”). Each of the interference RS resources may be associated with a different Tx beam used by the UE 120b and/or UE 120c to transmit uplink transmissions to the BS. In certain aspects, to transmit the interference RSs, the UE 120b and/or UE 120c may use the same or different Tx beam(s) previously used for uplink transmissions (e.g., PUSCH data transmissions) to the BS 110. In certain cases, the different interference RS resources may enable the UE 120b and UE 120c to sweep through different Tx beams and allow the UE 120a to determine the Rx beam(s) (e.g., Rx beams 406, 408) that exhibits the least interference associated with the interference RS resources.

For each of the interference RS resources configured in the reference signal configuration, the UE 120a may determine a Rx beam 406, 408 based on the monitored interference RSs. For example, the UE-120a may select the Rx beam 406 that exhibits the least interference from the interference RS resources 402 transmitted by the UE 120b. The UE 120a may select a similar Rx beam 408 that exhibits the least interference from the interference RS resource 404 transmitted by the UE 120c.

In certain cases, in the reference signal configuration, for example, the BS 110 may further configure the UE 120a to monitor channel state information reference signals (CSI-RS) resources 410, 412 (e.g., non-zero power CSI-RS (NZP-CSI-RS) resources) (or any other suitable reference signal transmitted by the BS 110) along with the interference RS resources. Each of the CSI-RS resources may be associated with at least one of the interference RS resources and allow the UE 120a to experience the potential interference encountered during full-duplex communications as described herein with respect to FIG. 3. For instance, the CSI-RS resources associated with the interference RS resources may be transmitted by the BS simultaneously with the corresponding interference RS resources. Each of the CSI-RS resources may be associated with the same or different interference RS resource(s).

The CSI-RSs 410, 412 corresponding to the CSI-RS resources may be transmitted by the BS 110. To transmit the CSI-RSs, the BS 110 may use the same or different Tx beams previously used for downlink transmissions (e.g., PDSCH data transmissions) to the UE 120a. Although the CSI-RSs 410, 412 are depicted as being transmitted on different Tx beams, the CSI-RSs 410, 412 may be transmitted using the same Tx beam. To transmit the CSI-RSs, the BS 110 may sweep through different Tx beams.

The UE 120a may take into account the CSI-RS resources when determining the Rx beams 406, 408 as previously described herein. For instance, the UE 120a may consider the CSI-RS resources to represent the signal and the interference RS resources to represent the interference in a signal-to-noise-and-interference assessment such as a signal-to-noise-and-interference ratio (SINR).

In certain aspects, the UE 120a may generate a beam interference report indicating interference levels encountered at the UE 120a while monitoring the interference RS resources and/or the CSI-RS resources. The interference report may include interference levels related to the interference RS resources and/or CSI-RS resources. For instance, the interference levels may include SINRs or interference power levels of the signals received on the interference RS resources and/or the CSI-RS resources. In the SINR measurements, the UE 120a may treat the CSI-RS resources transmitted by the BS as the signal and the interference RS resources as the interference. In certain cases, the UE 120a may monitor the interference to carry out averaging of the interference report over multiple monitoring occasions. For instance, the interference report may include interference levels averaged over multiple monitoring occasions.

The UE 120a may report (e.g., via the interference report) the measurement result for one or multiple preferred beams for all interference RS resources (e.g., SRS resources), or for each interference RS resource, one or multiple preferred beams, or report the measurement result for all swept beams regarding all interference RS resources. For example, the reporting of the measurement results may include one or any combination of (1) reporting of the beam indices of the preferred beams for a certain interference RS resource, (2) the interference RS resource indices of the involved interference RS resources, and (3) the CSI-RS resource indices associated with the involved interference RS resources. The specific report quantity may be based on a separate configuration from the BS, or determined by the UE and indicated to the BS.

As another example of the downlink beam refinement in full-duplex communications applications, UE-1 may monitor interference RS resource groups and determine one or more reception beams for receiving downlink transmission from the BS while receiving interfering signals from the UE-2(s).

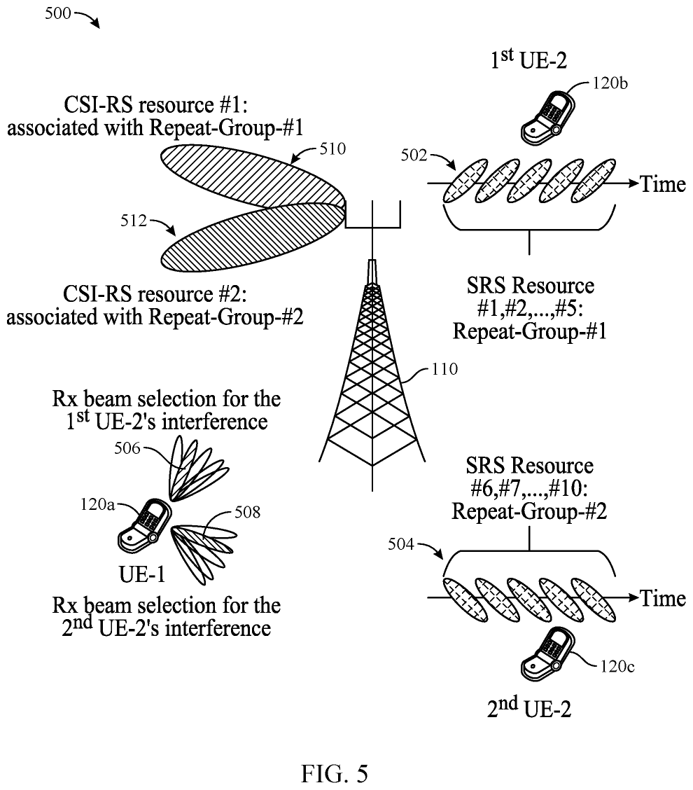

FIG. 5 illustrates an example full-duplex wireless communication system 500, where the UE 120a (e.g., UE-1) monitors interference reference signal resource groups configured by the reference signal configuration, wherein different interference reference signal resource groups are associated with reference signals transmitted from the different UEs 120b and 120c (e.g., UE-2s), in accordance with certain aspects of the present disclosure. As shown, the UE 120a may be configured with one or more interference RS resource group(s) (e.g., time and frequency resource groups) to monitor interference RSs 502, 504 transmitted from the UEs 120b and 120c, respectively, via uplink Tx beams.

The BS 110 may transmit, to the UE 120a, a reference signal resource configuration indicating the interference RS resource groups to monitor. For instance, the reference signal resource configuration may include one or more index values associated with the interference RS resource group(s). The UE 120a may determine the interference RS resource group(s) to monitor in accordance with the index values. The reference signal resource configuration may indicate to perform the monitoring of the one or more interference RS resource groups on a semi-persistent, periodic, aperiodic, or dynamic basis. The reference signal resource configuration may indicate the interference RS resource groups at a band or subband level of a carrier bandwidth.

Each of the interference RS resource groups may correspond to a set of interference RS resources. Each of the interference RS resources in the group may be set to repeat according to a repetition pattern and have the same or a different number of repetitions. Each of the interference RS resource groups may be associated with one or more Tx beam(s) used by the UE 120b and/or UE 120c to transmit uplink transmissions to the BS. In certain aspects, to transmit the interference RSs, the UE 120b and/or UE 120c may use the same or different Tx beam(s) previously used for uplink transmissions (e.g., PUSCH data transmissions) to the BS 110. In certain cases, where each of the resources in an interference RS group are associated with different TX beams, the interference RS resource group may enable the UE 120b and UE 120c to sweep through different Tx beams. In other cases, where each interference RS group is associated with a different Tx beam and the resources in the interference RS group are associated with the same Tx beam, the different interference RS resource group may enable the UE 120b and UE 120c to sweep through different Tx beams. The UE 120a may use the received RSs on the swept Tx beams to determine the Rx beam(s) (e.g., Rx beams 406, 408) that exhibit the least interference associated with each of the interference RS resource group or resources in the group.

For each of the interference RS resource groups, the UE 120a may determine a Rx beam 506, 508 based on the monitored interference RSs. For example, the UE-120a may select the Rx beam 506 that exhibits the least interference from the interference RS resource group(s) 502 transmitted by the UE 120b. The UE 120a may select a similar Rx beam 508 that exhibits the least interference from the interference RS resource group(s) 504 transmitted by the UE 120c.

In certain cases, the BS 110 may configure the UE 120a to monitor channel state information reference signals (CSI-RS) resources 510, 512 (e.g., NZP-CSI-RS resources) (or any other suitable reference signal transmitted by the BS 110) along with the interference RS resource groups. Each of the CSI-RS resources may be associated with at least one of the interference RS resource groups and allow the UE 120a to experience the potential interference encountered during full-duplex communications as described herein with respect to FIG. 3. For instance, the CSI-RS resources associated with the interference RS resource groups may be transmitted by the BS simultaneously with the corresponding interference RS resource groups. Each of the CSI-RS resources may be associated with the same or different interference RS resource group(s).

The CSI-RSs corresponding to the CSI-RS resources 510, 512 may be transmitted by the BS 110. To transmit the CSI-RSs, the BS 110 may use the same or different Tx beams previously used for downlink transmissions (e.g., PDSCH data transmissions) to the UE 120a. Although the CSI-RS resources 510, 512 are depicted as being transmitted on different Tx beams, the CSI-RS resources 510, 512 may be transmitted using the same Tx beam. In certain cases, the BS 110 may sweep through different Tx beams to transmit the CSI-RSs.

The UE 120a may take into account the CSI-RS resources when determining the Rx beams 506, 508 as previously described herein. In certain aspects, the UE 120a may generate a beam interference report indicating interference levels encountered at the UE 120a while monitoring the interference RS resource groups and/or the CSI-RS resources. The interference report may include interference levels related to the interference RS resources, the interference RS resource groups, and/or CSI-RS resources.

Certain aspects of the present disclosure provide techniques for signaling the interference RSs for quasi-colocation (QCL) information from the BS to the UEs. For example, the BS 110 may determine whether UE-1 should take into account one or several of the interference RS resources or interference RS groups when determining spatial reception parameters for quasi-colocated signaling.

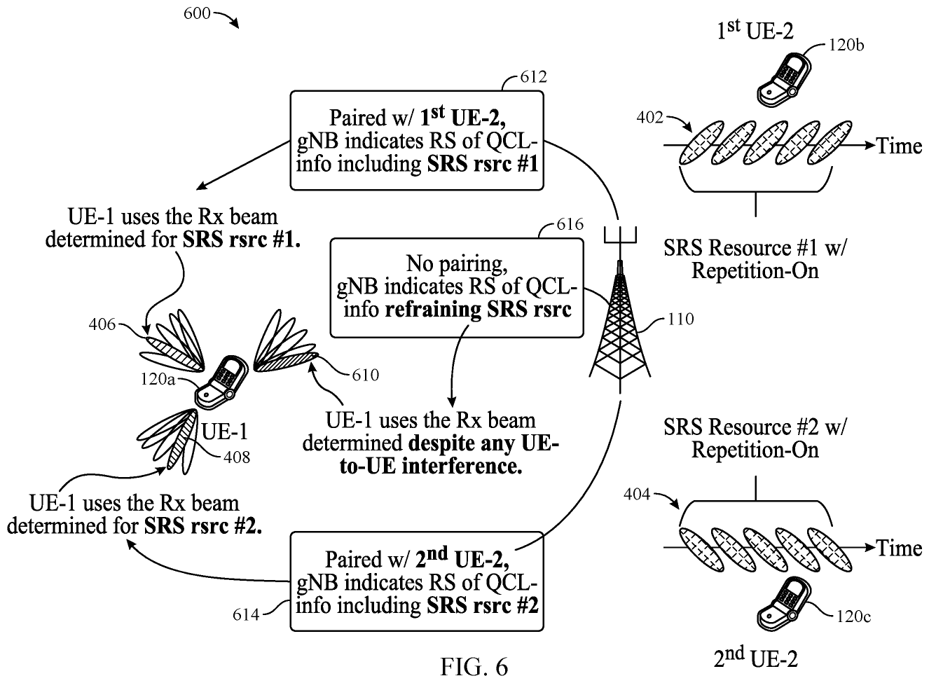

FIG. 6 illustrates an example full-duplex wireless communication system 600, where the BS 110 provides the QCL information with or without corresponding interference RSs, in accordance with certain aspects of the present disclosure. As shown, the BS 110 may transmit, to the UE 120a, control signaling 612, 614, 616 that indicates the QCL information with or without corresponding interference RS resources. For instance, the control signaling 612 may include an interference RS resource (e.g., the interference RS resource 402) or group for the QCL information. As an example, the control signaling 614 may include another interference RS resource (e.g., the interference RS resource 404) or group for the QCL information. In certain cases, the control signaling 616 may include QCL information without any interference RS resource. The control signaling 612, 614, 616 may be transmitted via downlink control information (DCI), radio resource control (RRC) signaling, and/or medium access control (MAC) signaling. The QCL information may be included in a transmission configuration indicator (TCI) state.

The UE 120a may select the Rx beam based on the QCL information in the control signaling. If the control signaling does not have any indication of interference RS resources, the UE 120a may use an Rx beam 610 regardless of the interference monitored from the UE 120a and/or UE 120c. If the control signaling indicates at least one interference RS resource, the UE 120a may use an Rx beam (e.g., Rx beam 406 or 408) to avoid interference from the full-duplex pairing with the UE 120b or 120c. If the control signaling indicates different interference RS resources or groups, the UE 120a may use different Rx beams (e.g., Rx beam 406 and 408) to avoid interference from the full-duplex communication from the UE 120b and 120c. In cases where the full-duplex pairing is subband-specific, the control signaling may include subband-specific QCL information with the interference RS resources or groups.

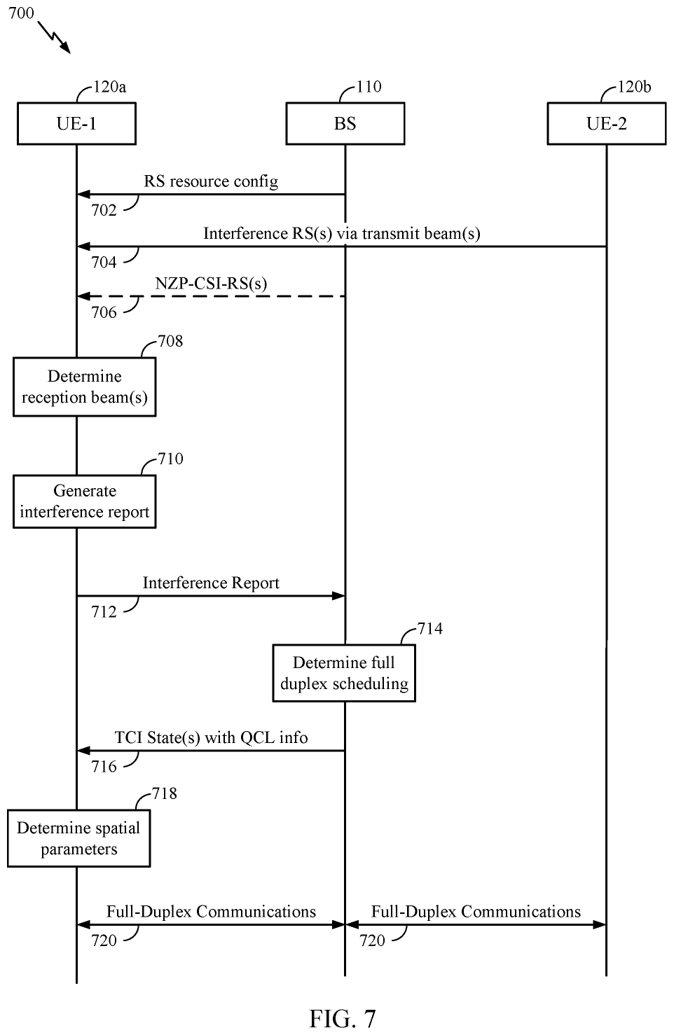

FIG. 7 is a signaling flow diagram illustrating example operations 700 for performing downlink beam management in a full-duplex setting, in accordance with certain aspects of the present disclosure. As shown, at 702, the UE 120a (e.g., UE-1) may receive a reference signal resource configuration from the BS 110 as described herein with respect to FIGS. 4 and 5. At 704, the UE 120a may determine interference RS resources or groups to monitor and monitor the interference RSs transmitted from the UE(s) 120b. At 704, the UE 120a may also monitor the CSI-RS resources (e.g., NZP-CSI-RS resources) transmitted from the BS 110. The CSI-RS resources may be transmitted simultaneously with the interference RS resources or groups. At 708, the UE 120a may determine an Rx beam for each of the interference RS resources or groups based on the monitored interference RSs and/or CSI-RSs. At 710, the UE 120a may generate a beam interference report including interference levels of the Rx beams. At 712, the UE 120a may transmit the interference report to the BS 110. At 714, the BS 110 may determine the full-duplex scheduling based on the interference report. For instance, the BS 110 may select UE pairings for full-duplex communications that exhibit the least interference from simultaneous transmissions as determined based on the interference report. The BS 110 may also determine whether the UE 120a is to apply the Rx beams determined at 708 for purposes of QCL information. At 716, the BS 110 may transmit, to the UE 120a, control signaling (e.g., TCI state(s)) with QCL information that indicate whether the UE 120a is to apply the Rx beams as described herein with respect to FIG. 6. At 718, the UE 120a may determine the spatial reception parameters for its Rx beams in accordance with the control signaling. At 720, the UEs 120a and 120b may engage in full-duplex communications with the BS 110. The UE 120a may receive downlink transmission from the BS 110 using the Rx beams that reduce interference from the uplink transmissions of the UE 120b.

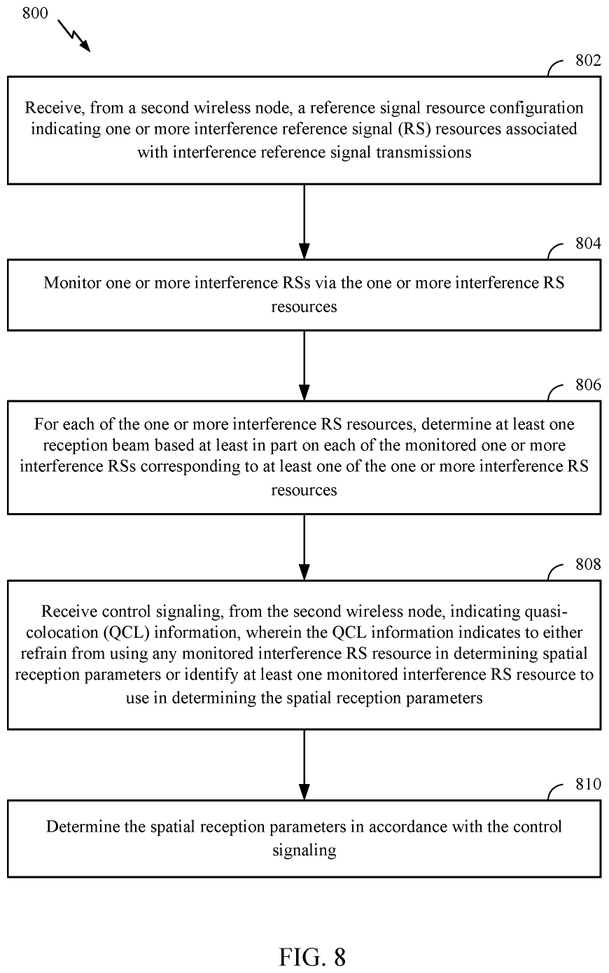

FIG. 8 is a flow diagram illustrating example operations 800 for determining a reception beam and applying the QCL information, in accordance with certain aspects of the present disclosure. The operations 800 may be performed, for example, by a first wireless node (e.g., UE 120a or UE-1). In certain aspects, the first wireless node may be child node or a relay node, as described in more detail herein.

Operations 800 may be implemented as software components that are executed and run on one or more processors (e.g., controller/processor 280 of FIG. 2). Further, the transmission and reception of signals by the UE in operations 800 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 800 may begin, at block 802, by a first wireless node (e.g., UE 120a) receiving, from a second wireless node (e.g., BS 110), a reference signal resource configuration indicating one or more interference reference signal (RS) resources associated with interference reference signal transmissions from other wireless nodes (e.g., UE 120b or 120c). At block 804, the first wireless node may monitor one or more interference RSs transmitted by the other wireless nodes via the one or more interference RS resources. At block 806, the first wireless node may determine, for each of the one or more interference RS resources, at least one reception beam based at least in part on each of the monitored one or more interference RSs corresponding to at least one of the one or more interference RS resources. At block 808, the first wireless node may receive control signaling, from the second wireless node, indicating QCL information. The QCL information may indicate to either refrain from using any monitored interference RS resource in determining spatial reception parameters or identify at least one monitored interference RS resource to use in determining the spatial reception parameters. At block 810, the first wireless node may determine the spatial reception parameters in accordance with the control signaling.

In certain aspects, determining the at least one reception beam at block 806 may be based on reducing interference associated with the monitored one or more interference RS resources.

The operations 800 may further include the first wireless node generating a beam interference report including interference levels of the at least one reception beam based at least in part on the monitored one or more interference RS resource. The first wireless node may transmit, to the second wireless node, the beam interference report.

The reference signal resource configuration may further indicate to perform averaging of the interference levels over a plurality of monitoring occasions (e.g., a number of slots, subframes, frames, seconds, or milliseconds). The first wireless node may generate the beam interference report by at least in part averaging the interference levels over the plurality of monitoring occasions.

The reference signal resource configuration may further indicate a number of interference RS repetitions over time associated with each of the one or more interference RS resources. In certain cases, all of the interference RS repetitions associated with one of the one or more interference RS resources may correspond to the transmission beam.

The reference signal resource configuration may further indicate one or more CSI-RS resources associated with CSI-RS transmissions from the second wireless node. Each of the one or more CSI-RS resources may be associated with at least one of the one or more interference RS resources. The monitoring by the first wireless node at block 804 may include monitoring one or more CSI-RSs from the second wireless node via the one or more CSI-RS resources. The generating of the beam interference report by the first wireless node may include generating the beam interference report based at least in part on the monitored one or more CSI-RSs. In certain aspects, a plurality of the one or more interference RS resources may be associated with the same CSI-RS resource. In other aspects, each of the one or more interference RS resources may be associated with a different resource of the one or more CSI-RS resources. The one or more CSI-RS resources may include at least one NZP-CSI-RS resource.

In certain aspects, determining the at least one reception beam at block 806 may be based on reducing interference associated with the monitored one or more interference RS resources. The interference associated with each monitored one or more interference RS resources may be determined based at least in part on one of the one or more interference RS resources and a corresponding CSI-RS resource of the one or more CSI-RS resources.

The beam interference report may indicate one or more interference levels associated with at least one of the monitored one or more interference RS resources or the one or more CSI-RS resources. The one or more interference levels may include at least one of an SINR or an interference power level. A signal power of an SINR of an interference RS resource or a CSI-RS resource may be determined based on the CSI-RS resource associated with the interference RS resource. An interference power of the SINR or the interference power level of an interference RS resource or a CSI-RS resource may be determined based on the interference RS resource.

The one or more interference RS resources may be SRS resources or CSI-RS resources that are different from the one or more CSI-RS resources transmitted by the second wireless node.

The control signaling received by the first wireless node at block 808 may indicate at least one interference RS resource for the QCL information. The operations 800 may further include the first wireless node identifying at least one interference RS resource from an indication of a TCI state with the QCL information included in the control signaling. Identifying the at least one interference RS resource by the first wireless node may include identifying explicitly from a monitored interference RS resource identifier (such as an index value corresponding to the resource) included in the control signaling or identifying implicitly using a monitored CSI-RS, transmitted by the second wireless node, that is associated with one of the monitored one or more interference RS resources.

The control signaling received by the first wireless node at block 808 may refrain from indicating any monitored interference RS resource for the QCL information. The operations 800 may further include the first wireless node identifying that an indication of a TCI state with the QCL information refrains from indicating any monitored interference RS for the QCL information in the control signaling.

If the control signaling indicates at least one interference RS resource from the monitored one or more interference RS resources for the QCL information, the first wireless may determine, at block 810, the spatial reception parameters based on the at least one interference RS resource indicated by the control signaling. In other aspects, if the control signaling refrains from indicating any interference RS resource for the QCL information, the first wireless node may determine, at block 810, the spatial reception parameters regardless of the monitored one or more interference RS resources.

The reference signal resource configuration may further indicate to perform the monitoring of the one or more interference RS resources on a semi-persistent, periodic, aperiodic, or dynamic basis. The first wireless node may monitor, at block 804, the one or more interference RSs on the semi-persistent, periodic, aperiodic, or dynamic basis indicated by the reference signal resource configuration.

Each of the one or more interference RS resources may correspond to at least one band or subband of a carrier bandwidth. For example, the reference signal resource configuration may further indicate the band or subband associated with each of the one or more interference RS resources.

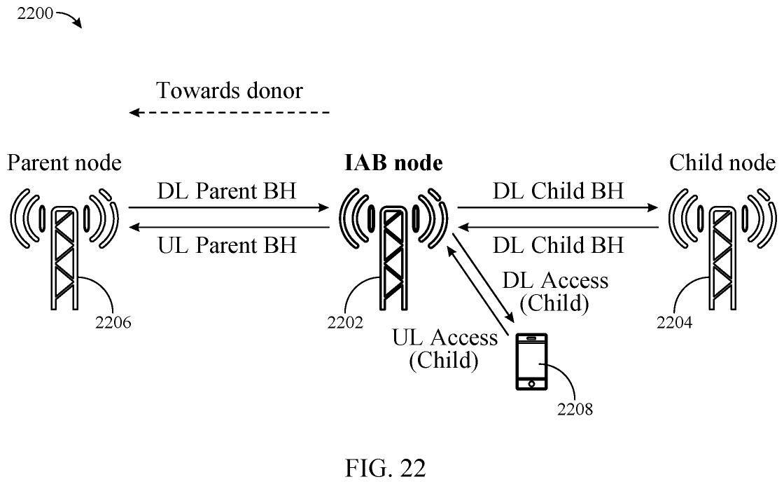

The first wireless node may be a user equipment, and the second wireless node may be a base station. The first wireless node may be a child node or relay node, and the second wireless node may be a donor node as further described herein with respect to FIG. 22.

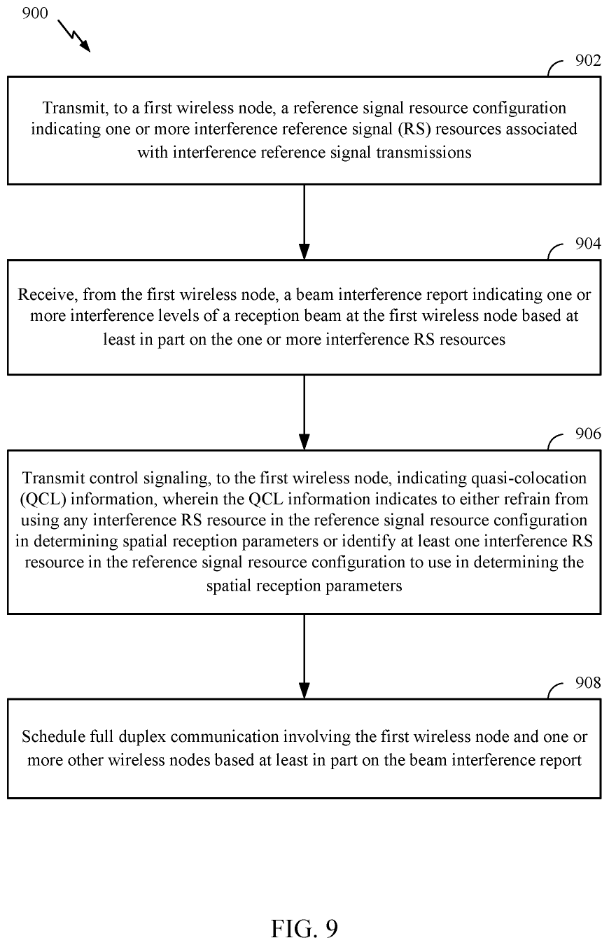

FIG. 9 is a flow diagram illustrating example operations 900 for scheduling full-duplex communications based on interference reported at the interference RS resource level, in accordance with certain aspects of the present disclosure. The operations 900 may be performed, for example, by a second wireless node (e.g., BS 110). In certain aspects, the second wireless node may be a donor node, as described in more detail herein.

The operations 900 may be complimentary to the operations 800 performed by the first wireless node. The operations 900 may be implemented as software components that are executed and run on one or more processors (e.g., controller/processor 240 of FIG. 2). Further, the transmission and reception of signals by the BS in operations 900 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 900 may begin, at block 902, by a second wireless node (e.g., BS 110) transmitting, to a first wireless node (e.g., UE 120a), a reference signal resource configuration indicating one or more interference reference signal (RS) resources associated with interference RS transmissions from other wireless nodes (e.g., UE 120b or 120c). At block 904, the second wireless node may receive, from the first wireless node, a beam interference report indicating one or more interference levels of a reception beam at the first wireless node based at least in part on the one or more interference RS resources. At block 906, the second wireless node may transmit control signaling, to the first wireless node, indicating QCL information. The QCL information may indicate to either refrain from using any interference RS resource in the reference signal resource configuration in determining spatial reception parameters or identify at least one interference RS resource in the reference signal resource configuration to use in determining the spatial reception parameters. At block 908, the second wireless node may schedule full duplex communications involving the first wireless node (e.g., UE 120a) and one or more other wireless nodes (e.g., UE 120b or 120c) based at least in part on the beam interference report.

At block 902, the reference signal resource configuration may further indicate to perform averaging of the interference levels over a plurality of monitoring occasions. The reference signal resource configuration may further indicate a number of interference RS repetitions over time associated with each of the one or more interference RS resources. In certain cases, all of the interference RS repetitions associated with one of the one or more interference RS resources may correspond to the same transmission beam.

The reference signal resource configuration may further indicate one or more CSI-RS resources associated with CSI-RS transmissions from the second wireless node. Each of the CSI-RS resource may be associated with at least one of the one or more interference RS resources. The beam interference report may indicate one or more interference levels based on at least one of the one or more interference RS resources or the one or more CSI-RS resources. In certain aspects, a plurality of the one or more interference RS resources may be associated with the same CSI-RS resource. In other aspects, each of the one or more interference RS resources may be associated with a different resource of the one or more CSI-RS resources. The one or more CSI-RS resources may include at least one NZP-CSI-RS resource.

The one or more interference RS resources may be SRS resources or CSI-RS resources that are different from the one or more CSI-RS resources transmitted by the second wireless node.

In certain aspects, the control signaling at block 906 further may indicate at least one interference RS resource for the QCL information. In other aspects, the control signaling may refrain from indicating any interference RS resource for the QCL information.

The reference signal resource configuration may further indicate to monitor the one or more interference RS resources on a semi-persistent, periodic, aperiodic, or dynamic basis.

Each of the one or more interference RS resources may correspond to at least one band or subband of a carrier bandwidth. For example, the reference signal resource configuration may further indicate the band or subband associated with each of the one or more interference RS resources.

The first wireless node may be a user equipment, and the second wireless node may be a base station. The first wireless node may be a child node or relay node, and the second wireless node may be a donor node as further described herein with respect to FIG. 22.

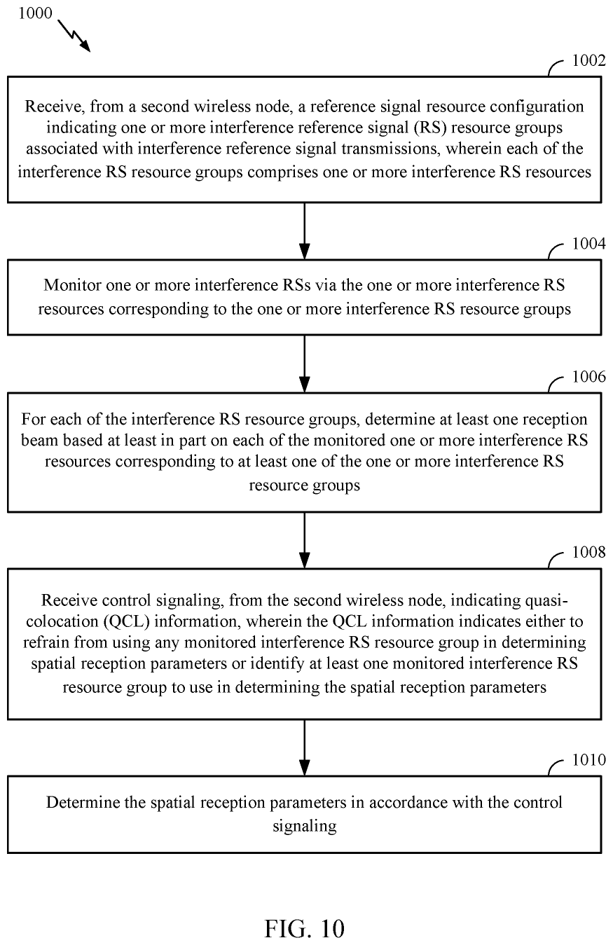

FIG. 10 is a flow diagram illustrating example operations 1000 for downlink beam management based on interference RS resource groups, in accordance with certain aspects of the present disclosure. The operations 1000 may be performed, for example, by a first wireless node (e.g., UE 120a or UE-1). In certain aspects, the first wireless node may be child node or relay node, as described in more detail herein.

The operations 1000 may be implemented as software components that are executed and run on one or more processors (e.g., controller/processor 280 of FIG. 2). Further, the transmission and reception of signals by the UE in operations 1000 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1000 may begin, at block 1002, by a first wireless node (e.g., UE 120a) receiving, from a second wireless node (e.g., BS 110), a reference signal resource configuration indicating one or more interference RS resource groups associated with interference reference signal transmissions. Each of the interference RS resource groups may include one or more interference RS resources. At block 1004, the first wireless node may monitor the one or more interference RSs via the one or more interference RS resources corresponding to the one or more interference RS resource groups. At block 1006, the first wireless node may determine, for each of the interference RS resource groups, at least one reception beam based at least in part on each of the monitored one or more interference RS resources corresponding to at least one of the one or more interference RS resource groups. At block 1008, the first wireless node may receive control signaling, from the second wireless node, indicating QCL information. The QCL information may indicate either to refrain from using any monitored interference RS resource group in determining spatial reception parameters or identify at least one monitored interference RS resource group to use in determining the spatial reception parameters. At block 1010, the first wireless node may determine the spatial reception parameters in accordance with the control signaling.

In certain aspects, determining the at least one reception beam at block 1006 may be based on reducing interference associated with the monitored one or more interference RS resource groups.

The operations 1000 may further include the first wireless node generating a beam interference report including interference levels of one or more of the determined reception beams based at least in part on the monitored one or more interference RS resource groups. The first wireless node may transmit, to the second wireless node, the beam interference report.

The reference signal resource configuration may further indicate to perform averaging of the interference levels over a plurality of monitoring occasions. The first wireless node may generate the beam interference report by at least in part averaging the interference levels over the plurality of monitoring occasions.

The reference signal resource configuration may further indicate a number of interference RS repetitions over time associated with each of the one or more interference RS resource groups. Each of the number of interference RS repetitions may be associated with an interference RS resource in one of the one or more interference RS resource groups. All of the interference RS repetitions associated with one of the one or more interference RS resources may correspond to the same transmission beam.

The reference signal resource configuration may further indicate one or more CSI-RS resources associated with CSI-RS transmissions from the second wireless node. Each of the one or more CSI-RS resources may be associated with at least one of the one or more interference RS resource groups. At block 1004, the first wireless node may monitor one or more CSI-RSs from the second wireless node via the one or more CSI-RS resources. The first wireless node may generate the beam interference report based at least in part on the monitored one or more CSI-RSs. In certain aspects, a plurality of the one or more interference RS resource groups may be associated with the same CSI-RS resource. In other aspects, each of the one or more interference RS resource groups may be associated with a different resource of the one or more CSI-RS resources. The one or more CSI-RS resources may include at least one NZP-CSI-RS resource.

In certain aspects, the first wireless node may determine the at least one reception beams based on reducing interference associated with the monitored one or more interference RS resource groups. The interference associated with each monitored one or more interference RS resource groups may be determined based at least in part on one of the one or more interference RS resource groups and a corresponding CSI-RS resource of the one or more CSI-RS resources.

The beam interference report may indicate one or more interference levels associated with at least one of the monitored one or more interference RS resource groups or the one or more CSI-RS resources. A signal power of an SINR of an interference RS resource group or a CSI-RS resource may be determined based on the CSI-RS resource associated with the interference RS resource group. An interference power of the SINR or the interference power level of an interference RS resource group or a CSI-RS resource may be determined based on the interference RS resource group.

The one or more interference RS resource groups may include SRS resources or CSI-RS resources that are different from the one or more CSI-RS resources transmitted by the second wireless node.

The control signaling received by the first wireless node at block 1008 may further indicate at least one interference RS for the QCL information. The operations 1000 may further include the first wireless node identifying at least one interference RS resource group from an indication of a TCI state with the QCL information included in the control signaling. Identifying the at least one interference RS resource group may include identifying explicitly from a monitored interference RS resource group identifier (such as an index value corresponding to the group) included in the control signaling or identifying implicitly using a monitored CSI-RS, transmitted by the second wireless node, that is associated with one of the monitored one or more interference RS resource groups.

The control signaling received by the first wireless node at block 1008 may refrain from indicating any monitored interference RS resource group for the QCL information. The operations 1000 may further include the first wireless node identifying that an indication of a TCI state with the QCL information refrains from indicating any monitored interference RS group for the QCL information in the control signaling.

If the control signaling indicates at least one interference RS group from the monitored one or more interference RS groups for the QCL information, the first wireless node may determine, at block 1010, the spatial reception parameters based on the at least one interference RS resource group indicated by the control signaling. If the control signaling does not indicate at least one interference RS for the QCL information, the first wireless node may determine, at block 1010, the spatial reception parameters regardless of the monitored one or more interference RS resource groups.

The reference signal resource configuration may further indicate to perform the monitoring of the one or more interference RS resource groups on a semi-persistent, periodic, aperiodic, or dynamic basis. The first wireless node may monitor, at block 1004, the one or more interference RSs on the semi-persistent, periodic, aperiodic, or dynamic basis indicated by the reference signal resource configuration.

Each of the one or more interference RS resource groups may correspond to at least one band or subband of a carrier bandwidth. For example, the reference signal resource configuration may further indicate the band or subband associated with each of the one or more interference RS resource groups.

The first wireless node may be a user equipment, and the second wireless node may be a base station. The first wireless node may be a child node, and the second wireless node may be a donor node as further described herein with respect to FIG. 22.

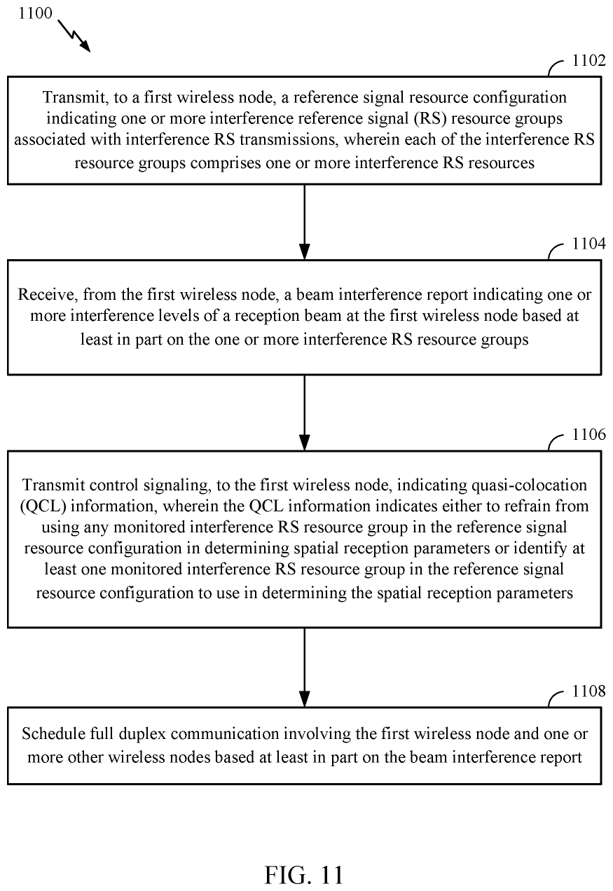

FIG. 11 is a flow diagram illustrating example operations 1100 for scheduling full-duplex communications based on interference reported at the interference RS resource group level, in accordance with certain aspects of the present disclosure. The operations 1100 may be performed, for example, by a second wireless node (e.g., BS 110). In certain aspects, the second wireless node may be a donor node, as described in more detail herein.

The operations 1100 may be complimentary to the operations 1000 performed by the UE. Operations 1100 may be implemented as software components that are executed and run on one or more processors (e.g., controller/processor 240 of FIG. 2). Further, the transmission and reception of signals by the BS in operations 1100 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 1100 may begin, at block 1102, by the second wireless node (e.g., BS 110) transmitting, to a first wireless node (e.g., UE 120a), a reference signal resource configuration indicating one or more interference RS resource groups associated with interference RS transmissions. Each of the interference RS resource groups may include one or more interference RS resources. At block 1104, the second wireless node may receive, from the first wireless node, a beam interference report indicating one or more interference levels of a reception beam at the first wireless node based at least in part on the one or more interference RS resource groups. At block 1106, the second wireless node may transmit control signaling, to the first wireless node, indicating QCL information. The QCL information may indicate either to refrain from using any monitored interference RS resource group in the reference signal resource configuration in determining spatial reception parameters or identify at least one monitored interference RS resource group in the reference signal resource configuration to use in determining the spatial reception parameters. At block 1108, the second wireless node may schedule full duplex communications involving the first wireless node and one or more other wireless nodes (e.g., UE 120b or 120c) based at least in part on the beam interference report.

At block 1102, the reference signal resource configuration may further indicate to perform averaging of the interference levels over a plurality of monitoring occasions. The reference signal resource configuration may further indicate a number of interference RS repetitions over time associated with each of the one or more interference RS resource groups. Each of the number of interference RS repetitions is associated with an interference RS resource in one of the one or more interference RS resource groups. All of the interference RS repetitions associated with one of the one or more interference RS resources may correspond to the same transmission beam.

The reference signal resource configuration may further indicate one or more CSI-RS resources associated with CSI-RS transmissions from the second wireless node. Each of the one or more CSI-RS resources may be associated with at least one of the one or more interference RS resource groups. The beam interference report may indicate the one or more interference levels based on at least one of the one or more interference RS resource groups or the one or more CSI-RS resources. In certain aspects, a plurality of the one or more interference RS resource groups may be associated with the same CSI-RS resource. In other aspects, each of the one or more interference RS resource groups may be associated with a different resource of the one or more CSI-RS resources. The one or more CSI-RS resources may include at least one NZP-CSI-RS resource.

The one or more interference RS resource groups may include SRS resources or CSI-RS resources that are different from the one or more CSI-RS resources transmitted by the second wireless node.

In certain aspects, the control signaling at block 1106 may further indicate at least one interference RS resource group for the QCL information. In other aspects, the control signaling may refrain from indicating any interference RS resource group for the QCL information.

The reference signal resource configuration may further indicate to monitor the one or more interference RS resource groups on a semi-persistent, periodic, aperiodic, or dynamic basis.

Each of the one or more interference RS resource groups may correspond to at least one band or subband of a carrier bandwidth. For example, the reference signal resource configuration may further indicate the band or subband associated with each of the one or more interference RS resource groups.

The first wireless node may be a user equipment, and the second wireless node may be a base station. The first wireless node may be a child node, and the second wireless node may be a donor node as further described herein with respect to FIG. 22.

### Example Uplink Beam Management Enhancementsfor Full Duplex

Certain aspects of the present disclosure provide techniques for uplink beam refinement in full-duplex communication applications. For example, UE-1 may monitor interference reference signal (RS) resources from one or more UE-2s and determine a preferred transmission beam for transmitting uplink transmissions to the BS while receiving interfering signals from the UE-2(s).

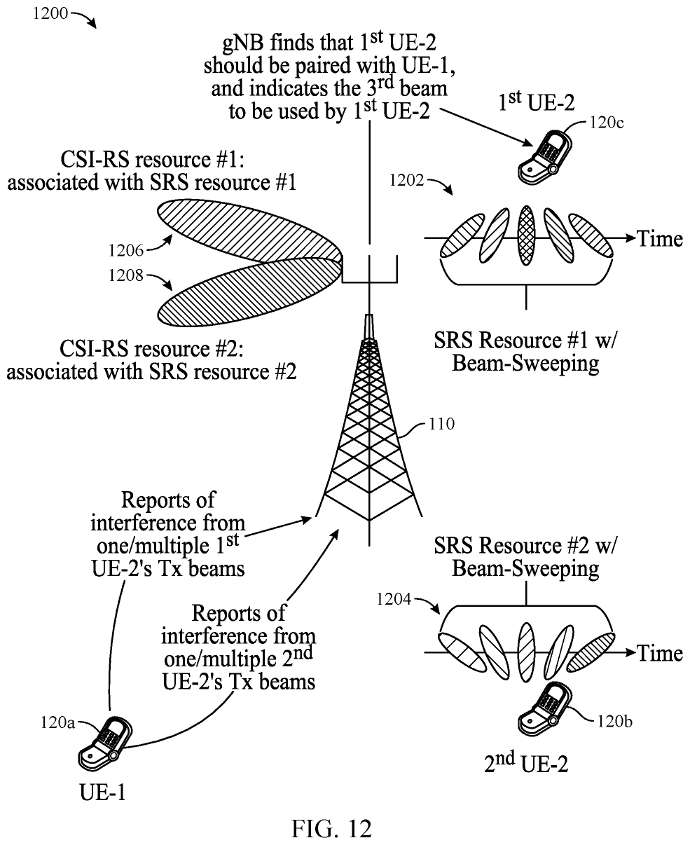

FIG. 12 is an example full-duplex wireless communication system 1200 for Tx beam refinement using beam sweeping for each SRS resource, in accordance with certain aspects of the present disclosure. For instance, certain aspects are directed to Tx beam refinement using beam sweeping for each SRS resource. As illustrated, UE-1 120a may be configured with multiple SRS resources 1202, 1204 to monitor, wherein each SRS resource is configured with transmit-beam-sweeping and each swept transmit beam has a beam index to facilitate feedback of the best transmit beam. For instance, UE-1 may measure the interference for one or more (e.g., a single, a portion, or all) of the swept beams corresponding to each SRS resource. The BS 110 may additionally configure CSI-RS (e.g., NZP-CSI-RS) resource(s) 1206, 1208 to UE-1 associated with the SRS resource(s), and indicate to UE-1 that UE-1 should take the CSI-RS as signal and take SRS as interference to calculate signal-to-interference-plus-noise ratio (SINR) as a measurement metric to be fed back to the BS 110.

In certain aspects, UE-1 may report (e.g., via the interference report) the measurement result for one or multiple preferred beams for all interference RS resources (e.g., SRS resources), or for each interference RS resource, one or multiple preferred beams, or report the measurement result for all swept beams regarding all interference RS resources. For example, the reporting of the measurement results may include one or any combination of (1) reporting of the beam indices of the preferred beams for a certain interference RS resource, (2) the interference RS resource indices of the involved interference RS resources, and (3) the CSI-RS resource indices associated with the involved interference RS resources.

For example, multiple UE-2s 120b, 120c (e.g., referred to as 1^{st} UE-2 and 2^{nd} UE-2, respectively) may be configured to sweep beams using respective SRS resources 1202, 1204 (e.g., SRS resource #1 and SRS resource #2), as illustrated in FIG. 12. The BS 110 may also transmit CSI-RSs via a CSI-RS resource #1 1206 associated with SRS resource #1 1202 and via CSI-RS resource #2 1208 associated with SRS resource #2 1204. In certain aspects, the CSI-RS transmissions may occur prior to the SRS transmissions, after the SRS transmissions, or may occur simultaneously. UE-1 may then report interference corresponding to one or multiple of the 1^{st} UE-2's swept Tx beams, as well as the 2^{nd} UE-2's swept Tx beams. For example, as described herein, UE-1 may consider the CSI-RS transmission from the BS 110 as the signal and the SRS of the swept beams as interference to calculate the SINR as a measurement metric, which may be fed back to the gNB (e.g., via the interference report described herein) for determining the UE pairing.

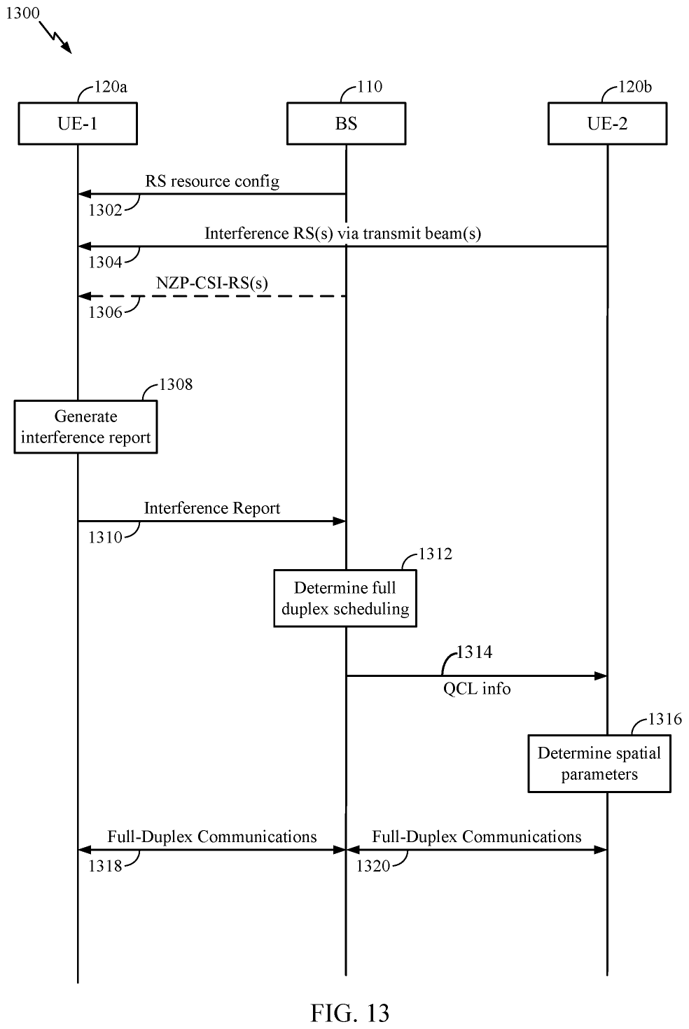

FIG. 13 is a signaling flow diagram illustrating example operations 1300 for beam management, in accordance with certain aspects of the present disclosure. As illustrated, at 1302, the BS 110 may send an RS resource configuration to UE 120a (e.g., UE-1) indicating interference RS resources to monitor. At 1304, the UE 120a may then receive the interference RSs via the interference RS resources as transmitted via transmit beams by UE-2 120b. In certain aspects, at 1306, the UE 120a may optionally receive CSI-RSs from the BS 110, as illustrated. At 1308, the UE 120a may generate an interference report indicating interference measurement results performed based on the interference RSs at 1304. At 1310, the interference report may be transmitted to BS 110 for determining full duplex scheduling at 1312. The BS 110 may then transmit quasi-co-location (QCL) information at 1314 to the UE 120b (e.g., UE-2) indicating spatial parameters for the UE 120a to determine spatial parameters at 1316, as described in more detail herein. The UE 120a and UE 120b may then perform full-duplex communications 1318, 1320 based on the spatial parameters, as configured.

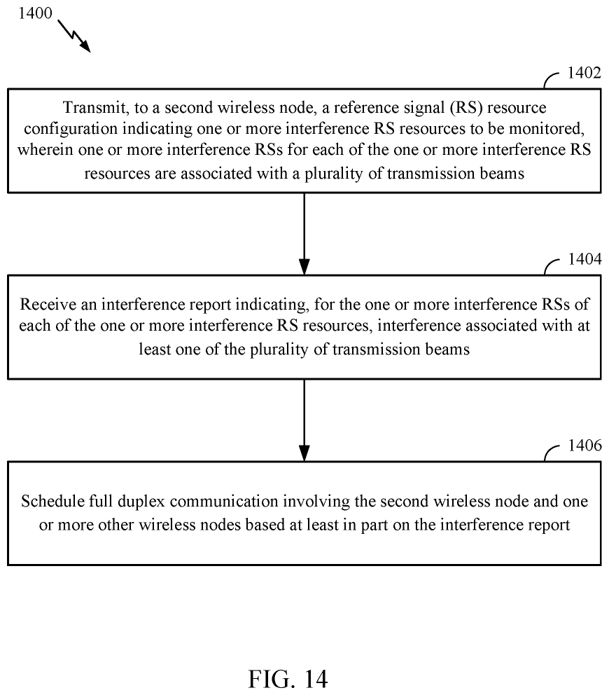

FIG. 14 is a flow diagram illustrating example operations 1400 for wireless communication, in accordance with certain aspects of the present disclosure. The operations 1400 may be performed, for example, by a first wireless node such as a BS (e.g., the BS 110 in the wireless communication network 100). Operations 1400 may be implemented as software components that are executed and run on one or more processors (e.g., controller/processor 240 of FIG. 2). Further, the transmission and reception of signals by the BS in operations 400 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals. In certain aspects, the operations 1400 may be performed by an integrated access or backhaul (LAB) node, for example, as described herein with respect to FIG. 22.

The operations 1400 begin, at block 1402, by the first wireless node transmitting, to a second wireless node (e.g., UE-1), a reference signal (RS) resource configuration indicating one or more interference RS resources (e.g., sounding reference signal (SRS) resources) to be monitored. The one or more interference RSs for each of the one or more interference RS resources may be associated with a plurality of transmission beams. In certain aspects, the operations 400 may also include transmitting, to one of the one or more other wireless nodes (e.g., UE-2), another RS resource configuration indicating the one or more interference RS resources for transmission of the one or more interference RSs for the one or more interference RS resources via the plurality of transmission beams.

At block 1404, the first wireless node receives an interference report indicating, for the one or more interference RSs of each of the one or more interference RS resources, interference associated with at least one of the plurality of transmission beams, and at block 1406, schedules full duplex communication involving the second wireless node and one or more other wireless nodes based at least in part on the interference report.

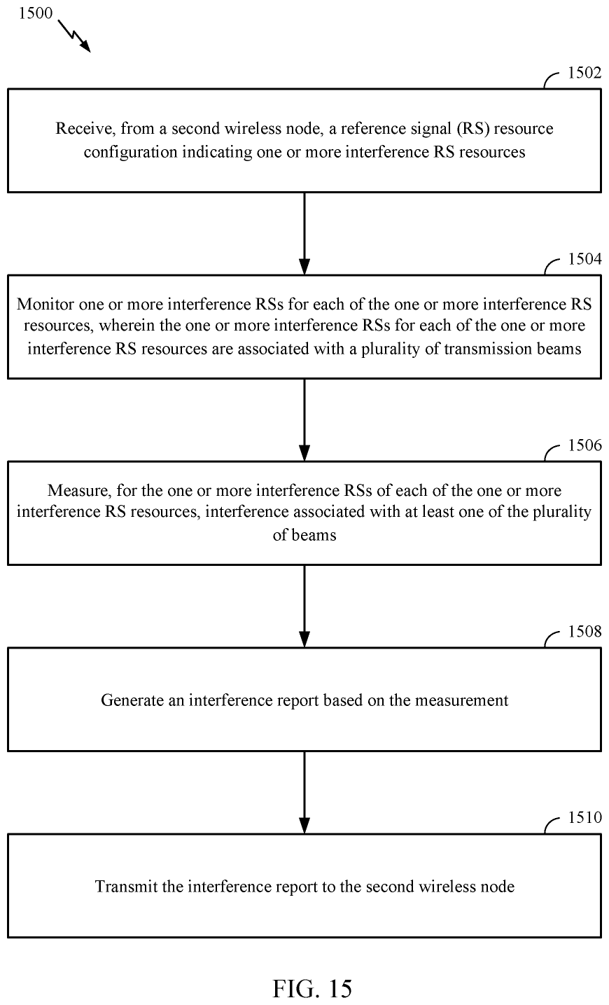

FIG. 15 is a flow diagram illustrating example operations 1500 for wireless communication, in accordance with certain aspects of the present disclosure. The operations 1500 may be performed, for example, by a first wireless node, such as a UE (e.g., the UE 120 in the wireless communication network 100). For example, the operations 1500 may be performed by UE-1, as described herein with respect to FIGS. 12 and 13.

The operations 1500 may be complimentary to the operations 1400 performed by the BS. Operations 1500 may be implemented as software components that are executed and run on one or more processors (e.g., controller/processor 280 of FIG. 2). Further, the transmission and reception of signals by the UE in operations 500 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals. In certain aspects, the first wireless node may be a child node, for example, as described herein with respect to FIG. 22.

The operations 1500 may begin, at block 1502, by the first wireless node (e.g., UE-1) receiving, from a second wireless node (e.g., BS 110), a reference signal (RS) resource configuration indicating one or more interference RS resources, and at block 1504, monitoring one or more interference RSs for each of the one or more interference RS resources. The one or more interference RSs for each of the one or more interference RS resources may be associated with a plurality of transmission beams. At block 1506, the first wireless node measures, for the one or more interference RSs of each of the one or more interference RS resources, interference associated with at least one of the plurality of beams, at block 1508, generates an interference report based on the measurement, and at block 1510, transmits the interference report to the second wireless node.

In some cases, the interference report may indicate one or more preferred beams of the plurality of transmission beams associated with a number of the one or more interference RS resources. The indication may include at least one of one or more beam indices associated with the one or more preferred beams for each of the number of the one or more interference RS resources, or one or more interference RS resource indices associated with each of the number of the one or more interference RS resources corresponding to the one or more preferred beams. In certain aspects, the interference report may also indicate the one or more preferred beams for the number of the one or more interference RS resources by indicating an interference level associated with each of the one or more preferred beams of the plurality of transmission beams for the number of the one or more interference RS resources.

In some cases, UE-1 may determine a quantity of the preferred beams for the number of the one or more interference RS resources. In other aspects, UE-1 may determine the quantity of the number of the one or more interference RS resources. The determination by UE-1 may be in accordance with at least one of the RS resource configuration or as predefined in a standard. In some cases, at least one of a quantity of preferred beams of the plurality of transmission beams for each of the number of the one or more interference RS resources may be equal to or less than the quantity of the associated plurality of beams, or may be only one. In some cases, the quantity of the number of the one or more interference RS resources may be equal to or less than the quantity of the one or more interference RS resources, or may be only one.

In certain aspects, the RS resource configuration may also indicate one or more channel state information reference signal (CSI-RS) resources (e.g. non-zero power (NZP) CSI-RS resources). Each of the one or more CSI-RS resources may be associated with at least one of the one or more interference RS resources. In this case, the first wireless node may also monitor at least one CSI-RS via each of the one or more CSI-RS resources, and measuring a receive signal parameter associated with the at least one CSI-RS for each of the one or more CSI-RS resources. The interference report may indicate the receive signal parameter associated with the at least one CSI-RS for each of the one or more CSI-RS resources. In certain aspects, the interference report indicates one or more CSI-RS indices associated with the one or more interference RS resources.

In certain aspects, the one or more interference RS resources may be a plurality of interference RS resources associated with the same CSI-RS resource, or each the one or more interference RS resources may be associated with a different one of the one or more CSI-RS resources. In some cases, the one or more interference RS resources may be one or more other CSI-RS resources that are different from the one or more CSI-RS resources, as described in more detail herein.

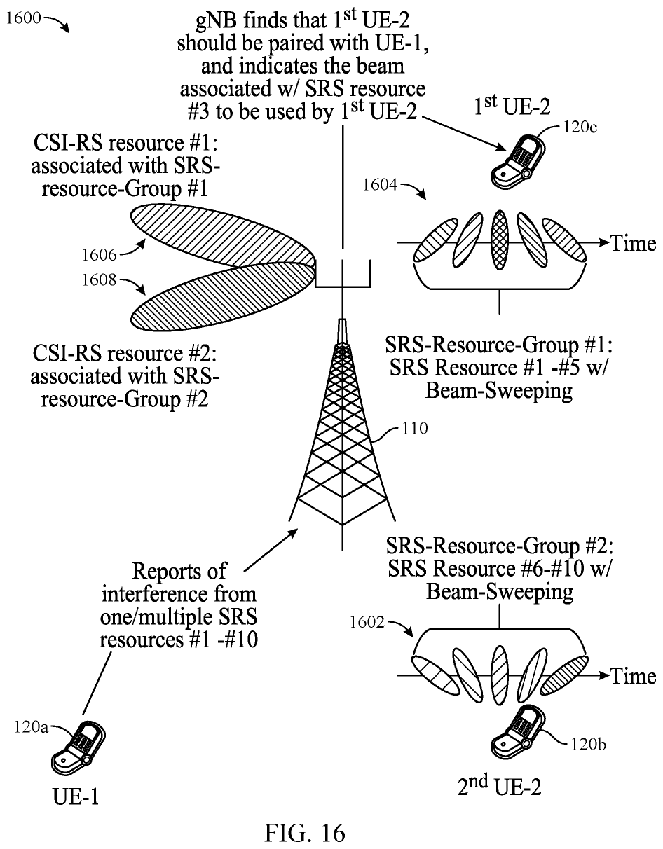

FIG. 16 is an example full-duplex wireless communication system 1600 for Tx beam refinement using beam-sweeping and interference RS resource groups 1602, 1604 (e.g., SRS resource groups), in accordance with certain aspects of the present disclosure. For example, the UE 120a (e.g., UE-1) may be configured with multiple interference RS resource groups 1602, 1604 (e.g., SRS resource groups) to monitor, each interference RS resource group being transmitted by the same UE 120b, 120c (e.g., UE-2). A s illustrated, the 1^{st} UE-2 may be configured with an interference RS resource group 1604 including interference RS resources #1 to #5. Thus, the UE 120c may perform beam sweeping using the interference RS resources #1 to #5. Similarly, the UE 120b may be configured with an interference RS resource group 1602 including interference RS resources #6-# 10 and perform beam sweeping using the configured interference RS resource group. The BS 110 may also transmit CSI-RSs using CSI-RS resource #1 1606 associated with the interference RS resource group #1 1604 and using CSI-RS resource #2 1608 associated with the interference RS resource group #2 1602. The UE 120a then monitors the resources for the CSI-RS and interference RS transmissions and measures the interference from a single, a portion of, or all of the interference RS resources to the CSI-RS transmission. For instance, as described herein, the BS 110 may configure CSI-RS resource(s) to the UE 120a associated with the SRS resource group(s). The UE 120a may consider the CSI-RS as signal and the SRS as interference to calculate SINR as a measurement metric to be reported. For example, the UE 120a may report the measurement result for one or multiple preferred SRS resources, which may be based on one or any combination of (1) the SRS resource group indices comprising the preferred SRS resources, (2) the SRS resource indices of the preferred SRS resources, and (3) the CSI-RS resource indices associated with the SRS resource groups comprising the preferred SRS resources.

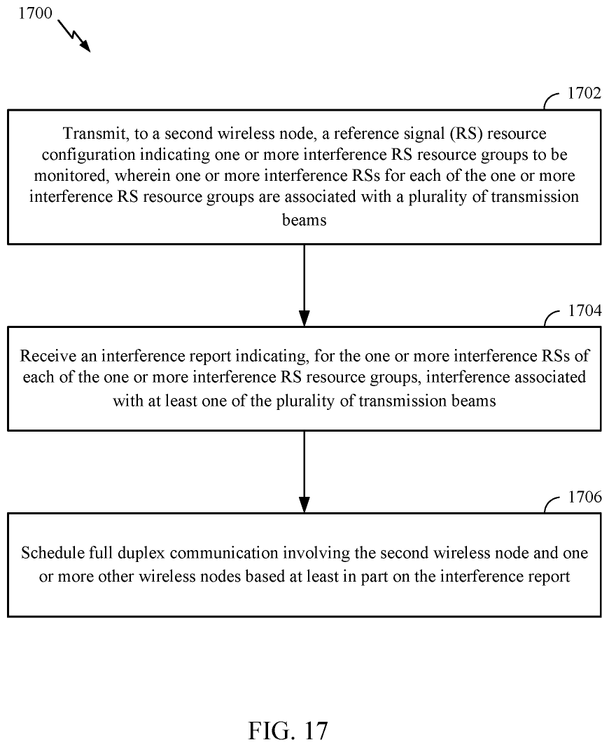

FIG. 17 is a flow diagram illustrating example operations 1700 for wireless communication, in accordance with certain aspects of the present disclosure. The operations 1700 may be performed, for example, by a first wireless node such as a BS (e.g., the BS 110 in the wireless communication network 100). Operations 1700 may be implemented as software components that are executed and run on one or more processors (e.g., controller/processor 240 of FIG. 2). Further, the transmission and reception of signals by the BS in operations 1700 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals. In certain aspects, the first wireless node may be an IAB node, for example, as described herein with respect to FIG. 22.

The operations 1700 begin, at block 1702, by the first wireless node transmitting, to a second wireless node (e.g., UE-2), a RS resource configuration indicating one or more interference RS resource groups (e.g., SRS resource groups) to be monitored. One or more interference RSs for each of the one or more interference RS resource groups may be associated with a plurality of transmission beams. At block 1704, the first wireless node receives an interference report indicating, for the one or more interference RSs of each of the one or more interference RS resource groups, interference associated with at least one of the plurality of transmission beams, and at block 1706, schedules full duplex communication involving the second wireless node and one or more other wireless nodes based at least in part on the interference report.

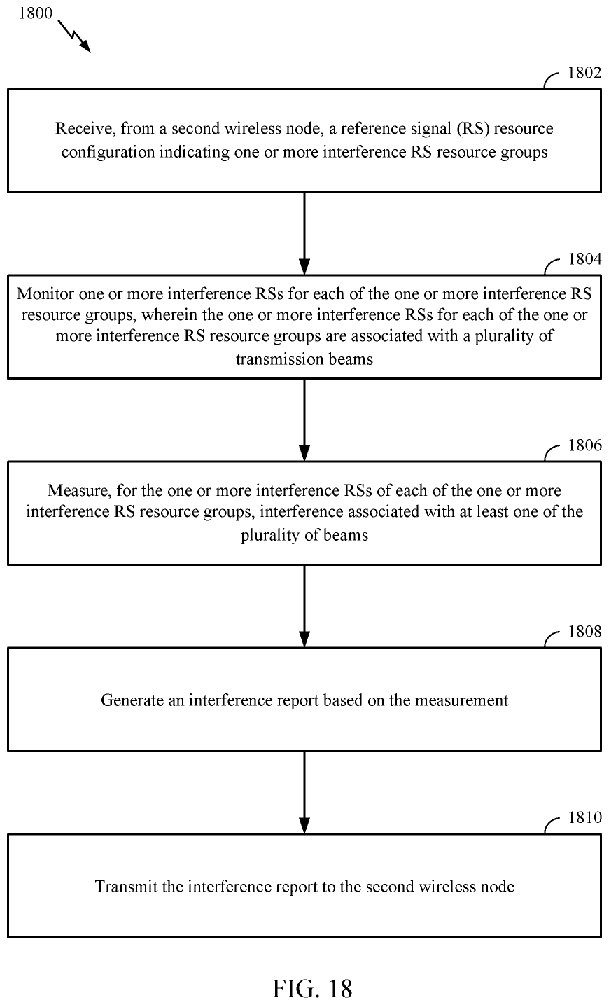

FIG. 18 is a flow diagram illustrating example operations 1800 for wireless communication, in accordance with certain aspects of the present disclosure. The operations 1800 may be performed, for example, by a first wireless node, such as a UE (e.g., the UE 120 in the wireless communication network 100). For example, the operations 1800 may be performed by UE-1, as described herein with respect to FIG. 16. In certain aspects, the first wireless node may be child node, for example, as described herein with respect to FIG. 22.

The operations 1800 may be complimentary to the operations 1700 performed by the BS. Operations 1800 may be implemented as software components that are executed and run on one or more processors (e.g., controller/processor 280 of FIG. 2). Further, the transmission and reception of signals by the UE in operations 800 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1800 may begin, at block 1802, by the first wireless node by receiving, from a second wireless node (e.g., BS 110), a RS resource configuration indicating one or more interference RS resource groups, and at block 1804, monitoring one or more interference RSs for each of the one or more interference RS resource groups. The one or more interference RSs for each of the one or more interference RS resource groups may be associated with a plurality of transmission beams. At block 1806, the first wireless node measures, for the one or more interference RSs of each of the one or more interference RS resource groups, interference associated with at least one of the plurality of beams, at block 1808, the first wireless node generates an interference report based on the measurement, and at block 1810, the first wireless node transmits the interference report to the second wireless node.

Certain aspects of the present disclosure are generally directed to Tx beam refinement using beam correspondence. For instance, beam correspondence may be present between a selected receive beam and a transmit beam. Thus, UE-2 may be configured to select a receive beam and use a corresponding transmit beam for transmissions, as described in more detail herein.

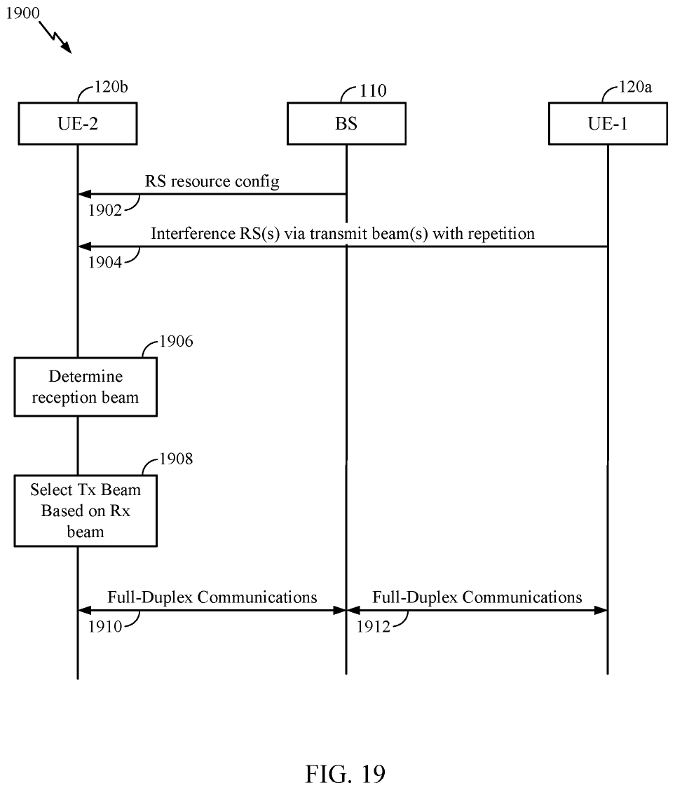

FIG. 19 is a signaling flow diagram illustrating example operations 1900 for beam management using beam correspondence, in accordance with certain aspects of the present disclosure. As illustrated, at 1902, the BS 110 may transmit an RS resource configuration to the UE 120b (e.g., UE-2) indicating one or more interference RS resources to be monitored. At 1904, the UE 120b may then receive interference RSs transmitted by the UE 120a (e.g., UE-1) via Tx beams with repetition, as described herein. At block 1906, the UE 120b may determine an Rx beam based on the one or more interference RSs, and at block 1908, the UE 120b may select a Tx beam corresponding to the determined Rx beam, which may be used for full-duplex communications 1910 simultaneously with the full-duplex communications 1912 by the UE 120a.

In certain aspects, Tx beam refinement using beam corresponding may be based on grouped SRS resources. For example, UE-2 may be configured with one or multiple SRS resources to monitor, at least a certain subset of the SRS resources being with repetition-on associated with the subset. A certain subset of SRS resources may be transmitted by the same UE-1. UE-1 may use the beam previously used for PUSCH transmission as the repeated beams, as described herein. For each subset of SRS resources with repetition-on, UE-2 may use the repetitions to find a best Rx beam. The best Rx beam may provide the lowest reception power at UE-2. UE-2 may use a Tx beam associated with the determined Rx beam, for any future PUSCH or SRS transmission associated with any of the UE-Us or SRS resource subsets involved in the Rx and Tx beam determination.

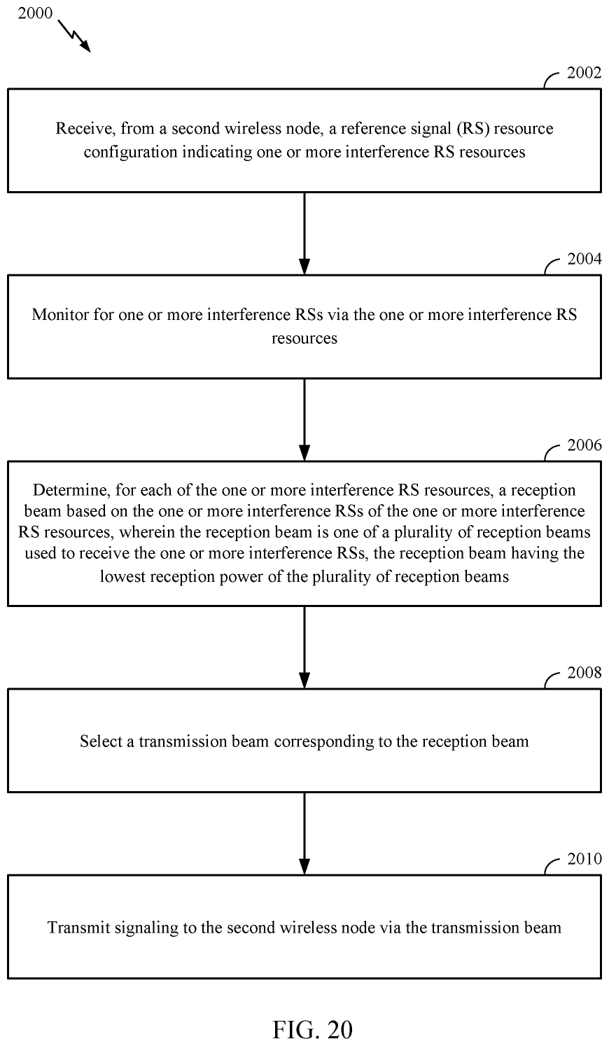

FIG. 20 is a flow diagram illustrating example operations 2000 for wireless communication, in accordance with certain aspects of the present disclosure. The operations 2000 may be performed, for example, by a first wireless node, such as a UE (e.g., the UE 120 in the wireless communication network 100). For example, the operations 2000 may be performed by the UE-1, as described herein with respect to FIG. 19. In certain aspects, the first wireless node may be a donor node, for example, as described herein with respect to FIG. 22.

Operations 2000 may be implemented as software components that are executed and run on one or more processors (e.g., controller/processor 280 of FIG. 2). Further, the transmission and reception of signals by the UE in operations 2000 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 2000 may begin, at block 2002, by the first wireless node receiving, from a second wireless node (e.g., BS 110), a RS resource configuration indicating one or more interference RS resources, and at block 2004, monitoring for one or more interference RSs via the one or more interference RS resources. At block 2006, the first wireless node may determine, for each of the one or more interference RS resources, a reception beam based on the one or more interference RSs of the one or more interference RS resources. The reception beam may be one of a plurality of reception beams used to receive the one or more interference RSs, the reception beam having the lowest reception power of the plurality of reception beams. At block 2008, the first wireless node selects a transmission beam corresponding to the reception beam (e.g., assuming correspondence between Rx and Tx beams), and at block 2010, transmits signaling to the second wireless node via the transmission beam.

For the selection of the reception beam, beam refinement may be performed based on multiple interference RS (e.g., SRS resources) resources, each interference RS resource being implemented with repetition. In otherwords, the same beam may be repeated across multiple interference RS resources by one UE (e.g., UE-1) to allow for another UE (e.g., UE-2) to select the best Rx beam, as described with respect to FIG. 19. For example, UE-2 may be configured with one or multiple SRS resources to monitor, each SRS resource being with repetition-on, as described herein. Each SRS resource may be transmitted by a certain UE-1. UE-1 may use the beam previously used for PUSCH transmission as the repeated beams. For each of the SRS resource repetitions, UE-2 may use the repetitions to find a best Rx beam. The best Rx beam may be the beam providing the lowest reception power at UE-2. Therefore, assuming correspondence between Tx and Rx beams, UE-2 may use a Tx beam associated with the determined Rx beam for any future PUSCH or SRS transmission associated with any of the UE-Us or SRS resources.

Certain aspects of the present disclosure are generally directed to the determination of spatial relation information for both full-duplex and half-duplex resources. For instance, the one or more interference RS resources described herein may be one or more full-duplex interference resources. In some cases, the RS resource configuration may also indicate one or more half-duplex interference RS resources. UE-1 may be configured to indicate, via the interference report described herein, another interference associated with each beam of the plurality of transmission beams for the one or more interference RSs of each of the one or more half-duplex interference RS resources.

In certain aspects, the BS 110 may transmit, to UE-2, an indication of quasi-colocation (QCL) information, the QCL information indicating first spatial relation information to use for transmissions via the one or more full-duplex interference resources and second spatial relation information to use for transmission via one or more half-duplex interference resources, and receive signaling from UE-2 in accordance with the QCL information, for example, as described herein with respect to FIG. 13. For example, the indication of QCL information may be in accordance with first spatial relation information for a UE-specific physical uplink control channel (PUCCH) transmission and may be composed by radio resource control (RRC), medium access control -control element (MAC-CE), or downlink control information (DCI), or the indication of QCL information may be in accordance with second spatial relation information for a UE-specific physical uplink shared channel (PUSCH) transmission and may be composed by RRC, MAC-CE, or DCI.

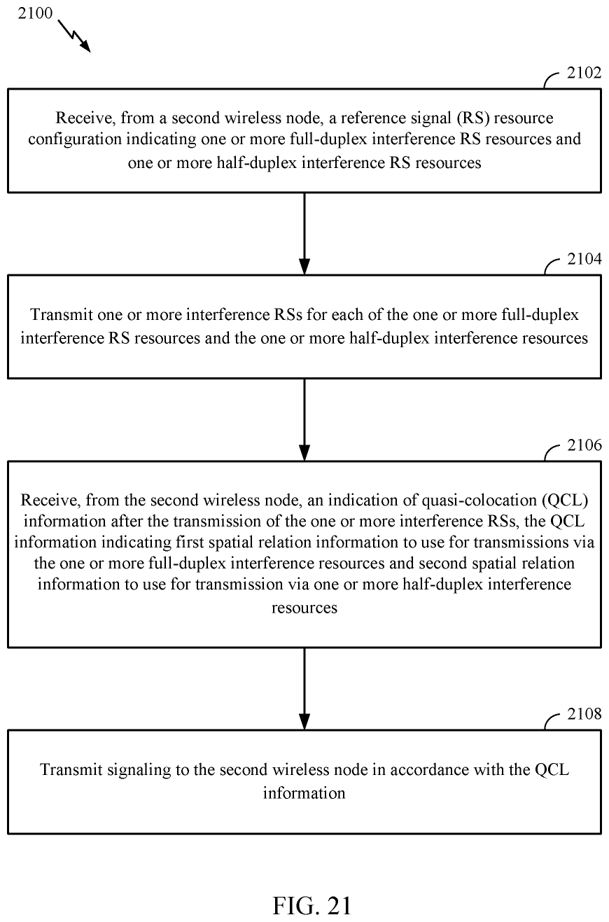

FIG. 21 is a flow diagram illustrating example operations 2100 for wireless communication, in accordance with certain aspects of the present disclosure. The operations 2100 may be performed, for example, by a first wireless node, such as a UE (e.g., the UE 120 in the wireless communication network 100). For example, the operations 2100 may be performed by the UE-2, as described herein with respect to FIGS. 13 and 19. In certain aspects, the first wireless node may be a donor node, for example, as described herein with respect to FIG. 22.

Operations 2100 may be implemented as software components that are executed and run on one or more processors (e.g., controller/processor 280 of FIG. 2). Further, the transmission and reception of signals by the UE in operations 2100 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 2100 may begin, at block 2102, by the first wireless node (e.g., UE-2) receiving, from a second wireless node (e.g., BS 110), a RS resource configuration indicating one or more full-duplex interference RS resources and one or more half-duplex interference RS resources, and at block 2104, transmitting one or more interference RSs for each of the one or more full-duplex interference RS resources and the one or more half-duplex interference resources. At block 2106, the first wireless node receives, from the second wireless node, an indication of QCL information after the transmission of the one or more interference RSs, the QCL information indicating first spatial relation information to use for transmissions via the one or more full-duplex interference resources and second spatial relation information to use for transmission via one or more half-duplex interference resources, and at block 2108, transmits signaling to the second wireless node in accordance with the QCL information.

For instance, for a UE specific PUCCH, the spatial relation information (e.g., also referred to as PUCCH-SpatialRelationInfo configuration) configured by higher layer or MAC-CE may include up to two resource indices, one for transmission in UL-only Tx resource (e.g., also referred to as half-duplex resource) and the other for transmission in full-duplex Tx resource. The selection of the RS for PUCCH Tx beam determination may be based on semi-static configured UL-only and full-duplex time-frequency resources. For instance, based on SRS resource with beam sweeping, the BS 110 may configure two SRS resources with beam sweeping to UE-2 for Tx beam refinement, one resource associated with UL-only transmission and the other resource associated with full-duplex transmission. After beam refinement measurements using the SRS resources, in the PUCCH-SpatialRelationInfo configuration, for each SRS resource, the BS 110 may configure one beam sweeping index as a Tx beam associated with the corresponding scenario (e.g., for the full-duplex and half-duplex resources).

Similarly, for the grouped SRS resources, the gNB may configure two SRS resource groups to UE-2 for Tx beam refinement, one group associated with UL-only transmission and the other group associated with full-duplex transmission. After beam refinement measurements using these SRS resource sets, in the PUCCH-SpatialRelationInfo configuration, for each resource set, the BS 110 may configure one SRS resource as a Tx beam associated with the corresponding scenario. In certain aspects, for dynamic scheduled PUSCH, the SRS resource indicator (SRI) indicated in downlink control information (DCI) scheduling of PUSCH may include at least two SRS resources, each providing the SpatialRelationInfo configuration for PUSCH transmission in UL-only and full-duplex resources respectively, when PUSCH transmission in a single slot includes a mixture of UL-only and full-duplex symbols.

In certain aspects of the present disclosure, the one or more interference RS resources may be SRS resources for SRS based monitoring, as described herein. In other aspects, CSI-RS resource based interference monitoring may be implemented. For instance, instead of SRS based monitoring and reporting, UE-1 and UE-2 may be configured by the BS 110 to transmit and/or monitor CSI-RS resources for interference measurement. The BS 110 may configure UE-2 and UE-1 to transmit RSs in the CSI-RS resources. The CSI-RS resources for interference measurement may be a single group, or multiple groups that are being separated from the CSI-RS resources transmitted by the BS for signal power measurement. In this case, the RSs transmitted by UE-2 and UE-1 may be a newly defined RS, or may be SRS. If CSI-RS is used for interference measurement, corresponding reports discussed herein (e.g., interference report) and the RS for QCL information indication may be associated with CSI-RS for interference measurement, instead of being SRS. In certain aspects, the configuration of the interference monitoring and reporting may be semi-persistent, periodic, aperiodic, or dynamic. In certain aspects, the BS may also configure UE monitoring interference to carry out averaging of the measurement metric over multiple monitoring occasions.

FIG. 22 illustrates an example wireless communication system 1200 for integrated access and backhaul (IAB), in accordance with certain aspects of the present disclosure. As shown, a wireless backhaul link may exist between an IAB-node (a donor node or relay node) 2202 and an IAB child node (relay node) 2204 or an IAB parent node (donor node) 2206. A wireless access link may exist between an access UE 2208 and the IAB-node 2202. While examples provided herein have been described with respect to beam management for a BS (e.g., gNB) and UEs (e.g., UE-1 and UE-2) to facilitate understanding, the techniques described herein may be applied to the IAB-node 2202, IAB child node 2204, and IAB parent node 2206. For example, the operations performed by the BS 110 as described herein may be performed by IAB-node 2202. The operations performed by UE-1 and UE-2, as described herein, may be performed by the IAB parent node 2206 and the IAB child node 2204, or vice versa.

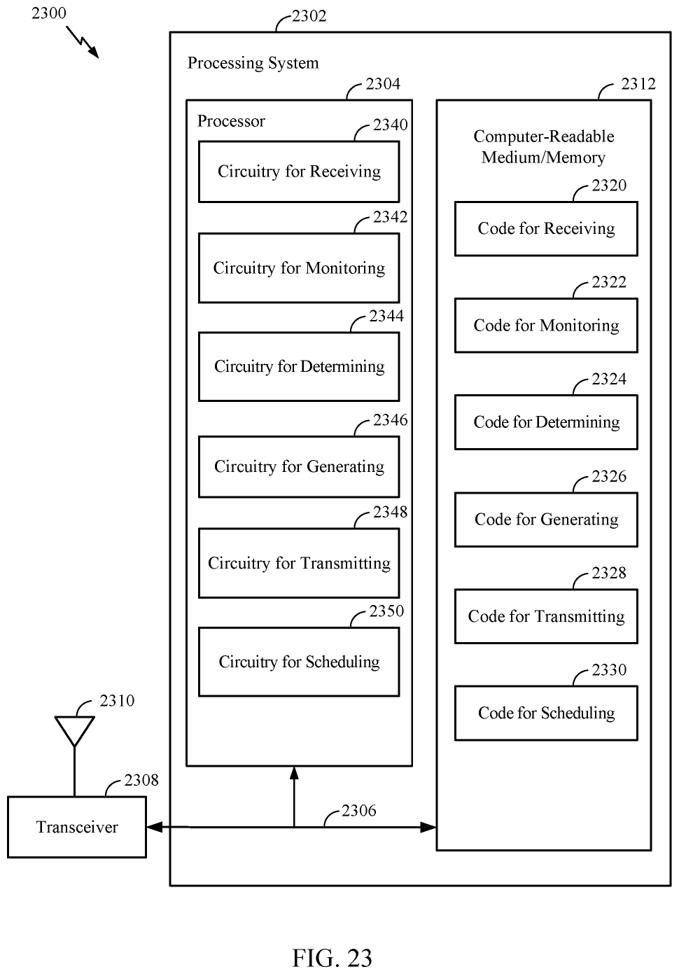

FIG. 23 illustrates a communications device 2300 (e.g., UE 120, BS 110, IAB-node 2202, child node 2204, or parent node 2206) that may include various components (e.g., corresponding to means-plus-function components) configured to perform operations for the techniques disclosed herein, such as the operations illustrated in FIGS. 7-11, 13-15, and 17-21. The communications device 2300 includes a processing system 2302 coupled to a transceiver 2308. The transceiver 2308 is configured to transmit and receive signals for the communications device 2300 via an antenna 2310, such as the various signals as described herein. The processing system 2302 may be configured to perform processing functions for the communications device 2300, including processing signals received and/or to be transmitted by the communications device 2300.

The processing system 2302 includes a processor 2304 coupled to a computer-readable medium/memory 2312 via a bus 2306. In certain aspects, the computer-readable medium/memory 2312 is configured to store instructions (e.g., computer-executable code) that when executed by the processor 2304, cause the processor 2304 to perform the operations illustrated in FIGS. 7-11, 13-15, and 17-21, or other operations for performing the various techniques discussed herein. In certain aspects, computer-readable medium/memory 2312 may store code for receiving 2320, code for monitoring 2322, code for determining 2324, code for generating 2326, code for transmitting 2328, and/or code for scheduling 2330. In certain aspects, the processor 2304 has circuitry configured to implement the code stored in the computer-readable medium/memory 2312. The processor 2304 may include circuitry for receiving 2340, circuitry for monitoring 2342, circuitry for determining 2344, circuitry for generating 2346, circuitry for transmitting 2348, and/or circuitry for scheduling 2350.

In addition to the examples described above, many examples of specific combinations are within the scope of the disclosure, some of which are detailed below:

Example 1. An apparatus for wireless communication, comprising: a receiver configured to: receive, from a wireless node, a reference signal resource configuration indicating one or more first interference reference signal (RS) resources associated with interference reference signal transmissions or one or more interference RS resource groups associated with the interference reference signal transmissions, wherein each of the interference RS resource groups comprises one or more second interference RS resources, and receive control signaling, from the wireless node, indicating quasi-colocation (QCL) information, wherein the QCL information indicates to either refrain from using any monitored interference RS resource in the reference signal resource configuration in determining spatial reception parameters or identify at least one monitored interference RS resource in the reference signal resource configuration to use in determining the spatial reception parameters; and a processing system configured to: monitor one or more interference RSs via the one or more first interference RS resources or the one or more second interference RS resources, determine, for each of the one or more first interference RS resources or each of the interference RS resource groups, at least one reception beam based at least in part on each of the monitored one or more interference RSs corresponding to at least one of the one or more first interference RS resources or the one or more second interference RS resources, and determine the spatial reception parameters in accordance with the control signaling.

Example 2. The apparatus of example 1, wherein: the processing system is configured to determine the at least one reception beam based on reducing interference associated with the monitored one or more first interference RS resources or the monitored one or more interference RS resource groups.

Example 3. The apparatus of example 1, wherein: the processing system is configured to generate a beam interference report including interference levels of the at least one reception beam based at least in part on the monitored one or more first interference RS resources or the monitored one or more interference RS resource groups; and the apparatus further comprises a transmitter configured to transmit, to the wireless node, the beam interference report.

Example 4. The apparatus according to any of the preceding examples, wherein: the reference signal resource configuration further indicates a number of interference RS repetitions over time associated with each of the one or more first interference RS resources or each of the one or more interference RS resource groups; and all of the interference RS repetitions associated with one of the one or more interference RS resources correspond to a same transmission beam.

Example 5. The apparatus of example 3, wherein: the reference signal resource configuration further indicates one or more channel state information reference signal (CSI-RS) resources associated with CSI-RS transmissions from the wireless node, wherein each of the one or more CSI-RS resources is associated with at least one of the one or more first interference RS resources or the one or more interference RS resource groups, and wherein the one or more CSI-RS resources includes at least one non-zero power CSI-RS resource; the processing system is configured to: monitor one or more CSI-RSs from the wireless node via the one or more CSI-RS resources, and generate the beam interference report based at least in part on the monitored one or more CSI-RSs.

Example 6. The apparatus according to any of examples 3-5, wherein the beam interference report indicates one or more interference levels associated with at least one of the monitored one or more first interference RS resources, the monitored one or more interference RS resource groups, or the one or more CSI-RS resources.

Example 7. The apparatus according to any of the preceding examples, wherein the one or more first interference RS resources are sounding reference signal (SRS) resources or CSI-RS resources that are different from the one or more CSI-RS resources transmitted by the wireless node, or wherein the one or more interference RS resource groups include SRS resources or CSI-RS resources that are different from the one or more CSI-RS resources transmitted by the wireless node.

Example 8. The apparatus of example 1, wherein: the control signaling further indicates at least one interference RS resource for the QCL information; and the processing system is configured to identify at least one interference RS resource from an indication of a transmission configuration indicator (TCI) state with the QCL information included in the control signaling.

Example 9. The apparatus of example 1, wherein: the control signaling refrains from indicating any monitored interference RS resource for the QCL information; and the processing system is configured to identify that an indication of a TCI state with the QCL information refrains from indicating any monitored interference RS for the QCL information in the control signaling, wherein the processing system is configured to: identify explicitly from a monitored interference RS resource identifier included in the control signaling; or identify implicitly using a monitored CSI-RS, transmitted by the wireless node, that is associated with one of the monitored one or more first interference RS resources or the monitored one or more interference RS resource groups.

Example 10. The apparatus according to any of the preceding examples, wherein the apparatus is a user equipment or a child node, and the wireless node is a base station or a donor node.

Example 11. An apparatus for wireless communication, comprising: a receiver configured to receive, from a wireless node, a reference signal (RS) resource configuration indicating one or more interference RS resources or one or more interference RS resource groups; a processing system configured to: monitor one or more interference RSs for each of the one or more interference RS resources or for each of the one or more interference RS resource groups, wherein the one or more interference RSs for each of the one or more interference RS resources or for each of the one or more interference RS resource groups are associated with a plurality of transmission beams, measure, for the one or more interference RSs of each of the one or more interference RS resources or each of the one or more interference RS resource groups, interference associated with at least one of the plurality of beams, and generate an interference report based on the measurement; and a transmitter configured to transmit the interference report to the wireless node.

Example 12. The apparatus of example 11, wherein the interference report indicates one or more preferred beams of the plurality of transmission beams associated with a number of the one or more interference RS resources or the one or more interference RS resource groups by at least one of: one or more beam indices associated with the one or more preferred beams for each of the number of the one or more interference RS resources or the one or more interference RS resource groups; or one or more interference RS resource indices associated with each of the number of the one or more interference RS resources or the one or more interference RS resource groups corresponding to the one or more preferred beams.

Example 13. The apparatus of example 12, wherein: the processing system is configured to determine at least one of a quantity of the preferred beams for the number of the one or more interference RS resources or the one or more interference RS resource groups, or the quantity of the number of the one or more interference RS resources or the one or more interference RS resource groups, wherein the determination is in accordance with at least one of the RS resource configuration or as predefined in a standard or determined by the UE without further configuration or predefinition.

Example 14. The apparatus of example 12, wherein, at least one of: a quantity of preferred beams of the plurality of transmission beams for each of the number of the one or more interference RS resources or the one or more interference RS resource groups equals or is less than the quantity of the associated plurality of beams, or is only one; or the quantity of the number of the one or more interference RS resources or the one or more interference RS resource groups equals or is less than the quantity of the one or more interference RS resources or the one or more interference RS resource groups, or is only one.

Example 15. The apparatus of one of examples 12-41, wherein the processing system is configured to determine the one or more preferred beam based on reducing interference associated with the monitored one or more interference RS resources, wherein the interference associated with one beam of the plurality of transmission beams is identified based at least in part on the interference RS associated with the beam.

Example 16. The apparatus according to any of the preceding examples, wherein: the RS resource configuration further indicates one or more channel state information reference signal (CSI-RS) resources, wherein each of the one or more CSI-RS resources is associated with at least one of the one or more interference RS resources or the one or more interference RS resource groups, wherein the one or more CSI-RS resources comprises at least one non-zero power CSI-RS resource; and the processing system is configured to: monitor at least one CSI-RS via each of the one or more CSI-RS resources; and measure a receive signal parameter associated with the at least one CSI-RS for each of the one or more CSI-RS resources, the interference report indicating the receive signal parameter associated with the at least one CSI-RS for each of the one or more CSI-RS resources.

Example 17. The apparatus of example 16, wherein the processing system is configured to calculate a signal-to-interference-plus-noise ratio (SINR) associated with at least one of the one or more interference RS resources or the one or more interference RS resource groups, wherein: an interference parameter of the SINR calculation corresponds to the interference associated with the at least one of the one or more interference RS resources or the one or more interference RS resource groups; a signal parameter of the SINR calculation is the receive signal parameter associated with a respective CSI-RS resource of the one or more CSI-RS resources; and the interference report indicates the SINR associated with the at least one of the one or more interference RS resources or the one or more interference RS resource groups.

Example 18. The apparatus according to any of the preceding examples, wherein: the one or more interference RS resources or the one or more interference RS resource groups comprises one or more full-duplex interference resources; the RS resource configuration further indicates one or more half-duplex interference RS resources; the processing system is configured to: monitor the one or more interference RSs via each of the one or more half-duplex interference RS resources; and measure another interference associated with each beam of the plurality of transmission beams for the one or more interference RSs of each of the one or more half-duplex interference RSs resources, the interference report being generated further based on the measured other interference.

Example 19. The apparatus according to any of the preceding examples, wherein the one or more interference RS resources are sounding reference signal (SRS) resources, or wherein the one or more interference RS resource groups are sounding reference signal (SRS) resource groups.

Example 20. The apparatus according to any of the preceding examples, wherein the apparatus is a user equipment (TIE) or a child node, and wherein the wireless node is a base station or a donor node.

Example 21. An apparatus for wireless communication, comprising: a receiver configured to receive, from a wireless node, a reference signal (RS) resource configuration indicating one or more interference RS resources; a processing system configured to: monitor for one or more interference RSs via the one or more interference RS resources; determine, for each of the one or more interference RS resources, a reception beam based on the one or more interference RSs of the one or more interference RS resources, wherein the reception beam is one of a plurality of reception beams used to receive the one or more interference RSs, the reception beam having the lowest reception power of the plurality of reception beams; and select a transmission beam corresponding to the reception beam; and a transmitter configured to transmit signaling to the wireless node via the transmission beam.

Example 22. The method of example 21, wherein the apparatus is a user equipment (TIE) or a child node, and wherein the wireless node is a base station or a donor node.

Example 23. An apparatus for wireless communication, comprising: a receiver configured to receive, from a wireless node, a reference signal (RS) resource configuration indicating one or more full-duplex interference RS resources and one or more half-duplex interference RS resources; a transmitter configured to transmit one or more interference RSs for each of the one or more full-duplex interference RS resources and the one or more half-duplex interference resources, wherein: the receiver is further configured to receive, from the wireless node, an indication of quasi-colocation (QCL) information after the transmission of the one or more interference RSs, the QCL information indicating first spatial relation information to use for transmissions via the one or more full-duplex interference resources and second spatial relation information to use for transmission via one or more half-duplex interference resources; and the transmitter is further configured to transmit signaling to the wireless node in accordance with the QCL information.

Example 24. The method of example 23, wherein the indication of QCL information is in accordance with first spatial relation information for a UE-specific physical uplink control channel (PUCCH) transmission and is composed by radio resource control (RRC), medium access control-control element (MAC-CE), or downlink control information (DCI); or the indication of QCL information is in accordance with second spatial relation information for a UE-specific physical uplink shared channel (PUSCH) transmission and is composed by RRC, MAC-CE, or DCI.

Example 25. The method of example 24, wherein: the interference RS resources are SRS resources, and the QCL information indicating the first and the second spatial information is comprised of a respective one of a first SRS resource indicator and a second SRS resource indicator.

Example 26. The method of example 23, wherein the apparatus is a user equipment (UE) or a child node, and wherein the second wireless node is a base station or a donor node.

Example 27. A method of wireless communication by a first wireless node, comprising: receiving, from a second wireless node, a reference signal resource configuration indicating one or more interference reference signal (RS) resources associated with interference reference signal transmissions; monitoring one or more interference RSs via the one or more interference RS resources; and for each of the one or more interference RS resources, determining at least one reception beam based at least in part on each of the monitored one or more interference RSs corresponding to at least one of the one or more interference RS resources; receiving control signaling, from the second wireless node, indicating quasi-colocation (QCL) information, wherein the QCL information indicates to either refrain from using any monitored interference RS resource in the reference signal resource configuration in determining spatial reception parameters or identify at least one monitored interference RS resource in the reference signal resource configuration to use in determining the spatial reception parameters; and determining the spatial reception parameters in accordance with the control signaling.

Example 28. The method of example 27, wherein: determining the at least one reception beam is based on reducing interference associated with the monitored one or more interference RS resources.

Example 29. The method of example 27, further comprising: generating a beam interference report including interference levels of the at least one reception beam based at least in part on the monitored one or more interference RS resources; and transmitting, to the second wireless node, the beam interference report.

Example 30. The method of example 29, wherein: the reference signal resource configuration further indicates to perform averaging of the interference levels over a plurality of monitoring occasions; and generating the beam interference report includes averaging the interference levels over the plurality of monitoring occasions.

Example 31. The method according to any of the preceding examples, wherein: the reference signal resource configuration further indicates a number of interference RS repetitions over time associated with each of the one or more interference RS resources; and all of the interference RS repetitions associated with one of the one or more interference RS resources correspond to a same transmission beam.

Example 32. The method of example 29, wherein: the reference signal resource configuration further indicates one or more channel state information reference signal (CSI-RS) resources associated with CSI-RS transmissions from the second wireless node, wherein each of the one or more CSI-RS resources is associated with at least one of the one or more interference RS resources; monitoring comprises monitoring one or more CSI-RSs from the second wireless node via the one or more CSI-RS resources; and generating the beam interference report comprises generating the beam interference report based at least in part on the monitored one or more CSI-RSs.

Example 33. The method of example 32, wherein a plurality of the one or more interference RS resources are associated with a same CSI-RS resource.

Example 34. The method of example 32, wherein each of the one or more interference RS resources is associated with a different resource of the one or more CSI-RS resources.

Example 35. The method of example 32, wherein the one or more CSI-RS resources includes at least one non-zero power CSI-RS resource.

Example 36. The method of example 32, wherein: determining the at least one reception beam is based on reducing interference associated with the monitored one or more interference RS resources, wherein the interference associated with each monitored one or more interference RS resources is determined based at least in part on one of the one or more interference RS resources and a corresponding CSI-RS resource of the one or more CSI-RS resources.

Example 37. The method according to any of examples 29-36, wherein the beam interference report indicates one or more interference levels associated with at least one of the monitored one or more interference RS resources or the one or more CSI-RS resources.

Example 38. The method of example 37, wherein: the one or more interference levels comprises at least one of a signal-to-interference-and-noise ratio (SINR) or an interference power level; a signal power of an SINR of an interference RS resource or a CSI-RS resource is determined based on the CSI-RS resource associated with the interference RS resource; and an interference power of the SINR or the interference power level of an interference RS resource or a CSI-RS resource is determined based on the interference RS resource.

Example 39. The method according to any of the preceding examples, wherein the one or more interference RS resources are sounding reference signal (SRS) resources or CSI-RS resources that are different from the one or more CSI-RS resources transmitted by the second wireless node.

Example 40. The method of example 27, wherein: the control signaling further indicates at least one interference RS resource for the QCL information; and the method further comprises identifying at least one interference RS resource from an indication of a transmission configuration indicator (TCI) state with the QCL information included in the control signaling.

Example 41. The method of example 27, wherein: the control signaling refrains from indicating any monitored interference RS resource for the QCL information; and the method further comprises identifying that an indication of a TCI state with the QCL information refrains from indicating any monitored interference RS for the QCL information in the control signaling.

Example 42. The method of example 41, wherein identifying the at least one interference RS resource further comprises: identifying explicitly from a monitored interference RS resource identifier included in the control signaling; or identifying implicitly using a monitored CSI-RS, transmitted by the second wireless node, that is associated with one of the monitored one or more interference RS resources.

Example 43. The method of example 27, wherein determining the spatial reception parameters comprises: if the control signaling indicates at least one interference RS resource from the monitored one or more interference RS resources for the QCL information, determining the spatial reception parameters based on the at least one interference RS resource indicated by the control signaling; or if the control signaling refrains from indicating any interference RS resource for the QCL information, determining the spatial reception parameters regardless of the monitored one or more interference RS resources.

Example 44. The method according to any of the preceding examples, wherein: the reference signal resource configuration further indicates to perform the monitoring of the one or more interference RS resources on a semi-persistent, periodic, aperiodic, or dynamic basis; and monitoring comprises monitoring the one or more interference RSs on the semi-persistent, periodic, aperiodic, or dynamic basis indicated by the reference signal resource configuration.

Example 45. The method according to any of the preceding examples, wherein the one or more interference RS resources correspond to at least one subband of a carrier bandwidth.

Example 46. The method according to any of the preceding examples, wherein the first wireless node is a user equipment, and the second wireless node is a base station.

Example 47. The method according to any of the preceding examples, wherein the first wireless node is a child node, and the second wireless node is a donor node.

Example 48. A method of wireless communication by a first wireless node, comprising: receiving, from a second wireless node, a reference signal resource configuration indicating one or more interference reference signal (RS) resource groups associated with interference reference signal transmissions, wherein each of the interference RS resource groups comprises one or more interference RS resources; monitoring one or more interference RSs via the one or more interference RS resources corresponding to the one or more interference RS resource groups; and for each of the interference RS resource groups, determining at least one reception beam based at least in part on each of the monitored one or more interference RS resources corresponding to at least one of the one or more interference RS resource groups; receiving control signaling, from the second wireless node, indicating quasi-colocation (QCL) information, wherein the QCL information indicates either to refrain from using any monitored interference RS resource group in the reference signal resource configuration in determining spatial reception parameters or identify at least one monitored interference RS resource group in the reference signal resource configuration to use in determining the spatial reception parameters; and determining the spatial reception parameters in accordance with the control signaling.

Example 49. The method of example 48, wherein: determining the at least one reception beam is based on reducing interference associated with the monitored one or more interference RS resource groups.

Example 50. The method of example 48, further comprising: generating a beam interference report including interference levels of one or more of the determined reception beams based at least in part on the monitored one or more interference RS resource groups; and transmitting, to the second wireless node, the beam interference report.

Example 51. The method of example 48, further comprising: wherein the reference signal resource configuration further indicates to perform averaging of the interference levels over a plurality of monitoring occasions; and wherein generating the beam interference report includes averaging the interference levels over the plurality of monitoring occasions.

Example 52. The method according to any of the preceding examples, wherein: the reference signal resource configuration further indicates a number of interference RS repetitions over time associated with each of the one or more interference RS resource groups; and each of the number of interference RS repetitions is associated with an interference RS resource in one of the one or more interference RS resource groups; and all of the interference RS repetitions associated with one of the one or more interference RS resources corresponds to a same transmission beam.

Example 53. The method of example 50, wherein: the reference signal resource configuration further indicates one or more channel state information reference signal (CSI-RS) resources associated with CSI-RS transmissions from the second wireless node, wherein each of the one or more CSI-RS resources is associated with at least one of the one or more interference RS resource groups; monitoring comprises monitoring one or more CSI-RSs from the second wireless node via the one or more CSI-RS resources; and generating the beam interference report comprises generating the beam interference report based at least in part on the monitored one or more CSI-RSs.

Example 54. The method of example 53, wherein a plurality of the one or more interference RS resource groups are associated with a same CSI-RS resource.

Example 55. The method of example 53, wherein each of the one or more interference RS resource groups is associated with a different resource of the one or more CSI-RS resources.

Example 56. The method of example 53, wherein the one or more CSI-RS resources includes at least one non-zero power CSI-RS resource.

Example 57. The method of example 53, wherein: determining the at least one reception beams is based on reducing interference associated with the monitored one or more interference RS resource groups, wherein the interference associated with each monitored one or more interference RS resource groups is determined based at least in part on one of the one or more interference RS resource groups and a corresponding CSI-RS resource of the one or more CSI-RS resources.

Example 58. The method according to any of examples 50-57, wherein the beam interference report indicates one or more interference levels associated with at least one of the monitored one or more interference RS resource groups or the one or more CSI-RS resources.

Example 59. The method of example 58, wherein: the one or more interference levels comprises at least one of a signal-to-interference-and-noise ratio (SINR) or an interference power level; a signal power of an SINR of an interference RS resource group or a CSI-RS resource is determined based on the CSI-RS resource associated with the interference RS resource group; and an interference power of the SINR or the interference power level of an interference RS resource group or a CSI-RS resource is determined based on the interference RS resource group.

Example 60. The method according to any of the preceding examples, wherein the one or more interference RS resource groups include sounding reference signal resources or CSI-RS resources that are different from the one or more CSI-RS resources transmitted by the second wireless node.

Example 61. The method of example 48, wherein: the control signaling further indicates at least one interference RS for the QCL information; and the method further comprises identifying at least one interference RS resource group from an indication of a transmission configuration indicator (TCI) state with the QCL information included in the control signaling.

Example 62. The method of example 48, wherein: the control signaling refrains from indicating any monitored interference RS group for the QCL information; and the method further comprises identifying that an indication of a TCI state with the QCL information refrains from indicating any monitored interference RS group for the QCL information in the control signaling.

Example 63. The method of example 61, wherein identifying the at least one interference RS resource group further comprises: identifying explicitly from a monitored interference RS resource group identifier included in the control signaling; or identifying implicitly using a monitored CSI-RS, transmitted by the second wireless node, that is associated with one of the monitored one or more interference RS resource groups.

Example 64. The method of example 48, wherein determining the spatial reception parameters comprises: if the control signaling indicates at least one interference RS group from the monitored one or more interference RS groups for the QCL information, determining the spatial reception parameters based on the at least one interference RS resource group indicated by the control signaling, or if the control signaling does not indicate at least one interference RS for the QCL information, determining the spatial reception parameters regardless of the monitored one or more interference RS resource groups.

Example 65. The method according to any of the preceding examples, wherein: the reference signal resource configuration further indicates to perform the monitoring of the one or more interference RS resource groups on a semi-persistent, periodic, aperiodic, or dynamic basis; and monitoring comprises monitoring the one or more interference RSs on the semi-persistent, periodic, aperiodic, or dynamic basis indicated by the reference signal resource configuration.

Example 66. The method according to any of the preceding examples, wherein the one or more interference RS resource groups correspond to at least one subband of a carrier bandwidth.

Example 67. The method according to any of the preceding examples, wherein the first wireless node is a user equipment, and the second wireless node is a base station.

Example 68. The method according to any of the preceding examples, wherein the first wireless node is a child node, and the second wireless node is a donor node.

Example 69. A method of wireless communication by a second wireless node, comprising: transmitting, to a first wireless node, a reference signal resource configuration indicating one or more interference reference signal (RS) resources associated with interference reference signal transmissions; receiving, from the first wireless node, a beam interference report indicating one or more interference levels of a reception beam at the first wireless node based at least in part on the one or more interference RS resources; transmitting control signaling, to the first wireless node, indicating quasi-colocation (QCL) information, wherein the QCL information indicates to either refrain from using any interference RS resource in the reference signal resource configuration in determining spatial reception parameters or identify at least one interference RS resource in the reference signal resource configuration to use in determining the spatial reception parameters; and scheduling full duplex communications involving the first wireless node and one or more other wireless nodes based at least in part on the beam interference report.

Example 70. The method of example 69, wherein the reference signal resource configuration further indicates to perform averaging of the interference levels over a plurality of monitoring occasions.

Example 71. The method according to examples 69 or 70, wherein: the reference signal resource configuration further indicates a number of interference RS repetitions over time associated with each of the one or more interference RS resources; and all of the interference RS repetitions associated with one of the one or more interference RS resources correspond to a same transmission beam.

Example 72. The method of example 71, wherein: the reference signal resource configuration further indicates one or more channel state information reference signal (CSI-RS) resources associated with CSI-RS transmissions from the second wireless node, wherein each of the CSI-RS resource is associated with at least one of the one or more interference RS resources; and the beam interference report indicates one or more interference levels based on at least one of the one or more interference RS resources or the one or more CSI-RS resources.

Example 73. The method of example 72, wherein a plurality of the one or more interference RS resources are associated with a same CSI-RS resource

Example 74. The method of example 72, wherein each of the one or more interference RS resources is associated with a different resource of the one or more CSI-RS resources.

Example 75. The method of example 72, wherein the one or more CSI-RS resources includes at least one non-zero power CSI-RS resource.

Example 76. The method according to any of the preceding examples, wherein the one or more interference RS resources are sounding reference signal (SRS) resources or CSI-RS resources that are different from the one or more CSI-RS resources transmitted by the second wireless node.

Example 77. The method of example 69, wherein the control signaling further indicates at least one interference RS resource for the QCL information.

Example 78. The method of example 69, wherein the control signaling refrains from indicating any interference RS resource for the QCL information.

Example 79. The method according to any of the preceding examples, the reference signal resource configuration further indicates to monitor the one or more interference RS resources on a semi-persistent, periodic, aperiodic, or dynamic basis.

Example 80. The method according to any of the preceding examples, wherein the one or more interference RS resources correspond to at least one subband of a carrier bandwidth.

Example 81. The method according to any of the preceding examples, wherein the first wireless node is a user equipment, and the second wireless node is a base station.

Example 82. The method according to any of the preceding examples, wherein the first wireless node is a child node, and the second wireless node is a donor node.

Example 83. A method of wireless communication by a second wireless node, comprising: transmitting, to a first wireless node, a reference signal resource configuration indicating one or more interference reference signal (RS) resource groups associated with interference RS transmissions, wherein each of the interference RS resource groups comprises one or more interference RS resources; receiving, from the first wireless node, a beam interference report indicating one or more interference levels of a reception beam at the first wireless node based at least in part on the one or more interference RS resource groups; transmitting control signaling, to the first wireless node, indicating quasi-colocation (QCL) information, wherein the QCL information indicates either to refrain from using any monitored interference RS resource group in the reference signal resource configuration in determining spatial reception parameters or identify at least one monitored interference RS resource group in the reference signal resource configuration to use in determining the spatial reception parameters; and scheduling full duplex communications involving the first wireless node and one or more other wireless nodes based at least in part on the beam interference report.

Example 84. The method of example 83, wherein the reference signal resource configuration further indicates to perform averaging of the interference levels over a plurality of monitoring occasions.

Example 85. The method according to examples 83 or 84, wherein: the reference signal resource configuration further indicates a number of interference RS repetitions over time associated with each of the one or more interference RS resource groups; each of the number of interference RS repetitions is associated with an interference RS resource in one of the one or more interference RS resource groups; and all of the interference RS repetitions associated with one of the one or more interference RS resources correspond to a same transmission beam.

Example 86. The method of example 85, wherein: the reference signal resource configuration further indicates one or more channel state information reference signal (CSI-RS) resources associated with CSI-RS transmissions from the second wireless node, wherein each of the one or more CSI-RS resources is associated with at least one of the one or more interference RS resource groups; and the beam interference report indicates one or more interference levels based on at least one of the one or more interference RS resource groups or the one or more CSI-RS resources.

Example 87. The method of example 85, wherein a plurality of the one or more interference RS resources are associated with a same CSI-RS resource.

Example 88. The method of example 85, wherein each of the one or more interference RS resources is associated with a different resource of the one or more CSI-RS resources.

Example 89. The method of example 85, wherein the one or more CSI-RS resources includes at least one non-zero power CSI-RS resource.

Example 90. The method according to any of the preceding examples, wherein the one or more interference RS resource groups include sounding reference signal (SRS) resources or CSI-RS resources that are different from the one or more CSI-RS resources transmitted by the second wireless node.

Example 91. The method of example 83, wherein the control signaling further indicates at least one interference RS group for the QCL information.

Example 92. The method of example 83, wherein the control signaling refrains from indicating any interference RS group for the QCL information.

Example 93. The method according to any of the preceding examples, the reference signal resource configuration further indicates to monitor the one or more interference RS resource groups on a semi-persistent, periodic, aperiodic, or dynamic basis.

Example 94. The method according to any of the preceding examples, wherein the one or more interference RS resource groups correspond to at least one subband of a carrier bandwidth.

Example 95. The method according to any of the preceding examples, wherein the first wireless node is a user equipment, and the second wireless node is a base station.

Example 96. The method according to any of the preceding examples, wherein the first wireless node is a child node, and the second wireless node is a donor node.

Example 97. An apparatus for wireless communication, comprising: a receiver configured to: receive, from a wireless node, a reference signal resource configuration indicating one or more interference reference signal (RS) resources associated with interference reference signal transmissions, and receive control signaling, from the wireless node, indicating quasi-colocation (QCL) information, wherein the QCL information indicates to either refrain from using any monitored interference RS resource in the reference signal resource configuration in determining spatial reception parameters or identify at least one monitored interference RS resource in the reference signal resource configuration to use in determining the spatial reception parameters; and a processing system configured to: monitor one or more interference RSs via the one or more interference RS resources, determine, for each of the one or more interference RS resources, at least one reception beam based at least in part on each of the monitored one or more interference RSs corresponding to at least one of the one or more interference RS resources, and determine the spatial reception parameters in accordance with the control signaling.

Example 98. An apparatus for wireless communication, comprising: a receiver configured to: receive, from a wireless node, a reference signal resource configuration indicating one or more interference reference signal (RS) resource groups associated with interference reference signal transmissions, wherein each of the interference RS resource groups comprises one or more interference RS resources, and receive control signaling, from the wireless node, indicating quasi-colocation (QCL) information, wherein the QCL information indicates either to refrain from using any monitored interference RS resource group in the reference signal resource configuration in determining spatial reception parameters or identify at least one monitored interference RS resource group in the reference signal resource configuration to use in determining the spatial reception parameters; and a processing system configured to: monitor one or more interference RSs via the one or more interference RS resources corresponding to the one or more interference RS resource groups, determine, for each of the interference RS resource groups, at least one reception beam based at least in part on each of the monitored one or more interference RS resources corresponding to at least one of the one or more interference RS resource groups, and determine the spatial reception parameters in accordance with the control signaling.

Example 99. An apparatus for wireless communication, comprising: a transmitter configured to: transmit, to a wireless node, a reference signal resource configuration indicating one or more interference reference signal (RS) resources associated with interference reference signal transmissions, and transmit control signaling, to the wireless node, indicating quasi-colocation (QCL) information, wherein the QCL information indicates to either refrain from using any interference RS resource in the reference signal resource configuration in determining spatial reception parameters or identify at least one interference RS resource in the reference signal resource configuration to use in determining the spatial reception parameters; a receiver configured to receive, from the wireless node, a beam interference report indicating one or more interference levels of a reception beam at the wireless node based at least in part on the one or more interference RS resources; and a processing system configured to schedule full duplex communications involving the wireless node and one or more other wireless nodes based at least in part on the beam interference report.

Example 100. An apparatus for wireless communication, comprising: a transmitter configured to: transmit, to a wireless node, a reference signal resource configuration indicating one or more interference reference signal (RS) resources associated with interference reference signal transmissions, and transmit control signaling, to the wireless node, indicating quasi-colocation (QCL) information, wherein the QCL information indicates to either refrain from using any interference RS resource in the reference signal resource configuration in determining spatial reception parameters or identify at least one interference RS resource in the reference signal resource configuration to use in determining the spatial reception parameters; a receiver configured to receive, from the wireless node, a beam interference report indicating one or more interference levels of a reception beam at the wireless node based at least in part on the one or more interference RS resources; and a processing system configured to schedule full duplex communications involving the wireless node and one or more other wireless nodes based at least in part on the beam interference report.

Example 101. An apparatus for wireless communication, comprising: means for receiving, from a wireless node, a reference signal resource configuration indicating one or more interference reference signal (RS) resources associated with interference reference signal transmissions; means for monitoring one or more interference RSs via the one or more interference RS resources; and means for determining, for each of the one or more interference RS resources, at least one reception beam based at least in part on each of the monitored one or more interference RSs corresponding to at least one of the one or more interference RS resources; means for receiving control signaling, from the wireless node, indicating quasi-colocation (QCL) information, wherein the QCL information indicates to either refrain from using any monitored interference RS resource in the reference signal resource configuration in determining spatial reception parameters or identify at least one monitored interference RS resource in the reference signal resource configuration to use in determining the spatial reception parameters; and means for determining the spatial reception parameters in accordance with the control signaling.

Example 102. An apparatus for wireless communication, comprising: means for receiving, from a wireless node, a reference signal resource configuration indicating one or more interference reference signal (RS) resource groups associated with interference reference signal transmissions, wherein each of the interference RS resource groups comprises one or more interference RS resources; means for monitoring one or more interference RSs via the one or more interference RS resources corresponding to the one or more interference RS resource groups; and means for determining, for each of the interference RS resource groups, at least one reception beam based at least in part on each of the monitored one or more interference RS resources corresponding to at least one of the one or more interference RS resource groups; means for receiving control signaling, from the wireless node, indicating quasi-colocation (QCL) information, wherein the QCL information indicates either to refrain from using any monitored interference RS resource group in the reference signal resource configuration in determining spatial reception parameters or identify at least one monitored interference RS resource group in the reference signal resource configuration to use in determining the spatial reception parameters; and means for determining the spatial reception parameters in accordance with the control signaling.

Example 103. An apparatus for wireless communication, comprising: means for transmitting, to a wireless node, a reference signal resource configuration indicating one or more interference reference signal (RS) resources associated with interference reference signal transmissions; means for receiving, from the wireless node, a beam interference report indicating one or more interference levels of a reception beam at the wireless node based at least in part on the one or more interference RS resources; means for transmitting control signaling, to the wireless node, indicating quasi-colocation (QCL) information, wherein the QCL information indicates to either refrain from using any interference RS resource in the reference signal resource configuration in determining spatial reception parameters or identify at least one interference RS resource in the reference signal resource configuration to use in determining the spatial reception parameters; and means for scheduling full duplex communications involving the wireless node and one or more other wireless nodes based at least in part on the beam interference report.

Example 104. An apparatus for wireless communication, comprising: means for transmitting, to a wireless node, a reference signal resource configuration indicating one or more interference reference signal (RS) resource groups associated with interference RS transmissions, wherein each of the interference RS resource groups comprises one or more interference RS resources; means for receiving, from the wireless node, a beam interference report indicating one or more interference levels of a reception beam at the wireless node based at least in part on the one or more interference RS resource groups; means for transmitting control signaling, to the wireless node, indicating quasi-colocation (QCL) information, wherein the QCL information indicates either to refrain from using any monitored interference RS resource group in the reference signal resource configuration in determining spatial reception parameters or identify at least one monitored interference RS resource group in the reference signal resource configuration to use in determining the spatial reception parameters; and means for scheduling full duplex communications involving the wireless node and one or more other wireless nodes based at least in part on the beam interference report.

Example 105. A computer readable medium having instructions stored thereon for: receiving, from a wireless node, a reference signal resource configuration indicating one or more interference reference signal (RS) resources associated with interference reference signal transmissions; monitoring one or more interference RSs via the one or more interference RS resources; for each of the one or more interference RS resources, determining at least one reception beam based at least in part on each of the monitored one or more interference RSs corresponding to at least one of the one or more interference RS resources; receiving control signaling, from the wireless node, indicating quasi-colocation (QCL) information, wherein the QCL information indicates to either refrain from using any monitored interference RS resource in the reference signal resource configuration in determining spatial reception parameters or identify at least one monitored interference RS resource in the reference signal resource configuration to use in determining the spatial reception parameters; and determining the spatial reception parameters in accordance with the control signaling.

Example 106. A computer readable medium having instructions stored thereon for: receiving, from a wireless node, a reference signal resource configuration indicating one or more interference reference signal (RS) resource groups associated with interference reference signal transmissions, wherein each of the interference RS resource groups comprises one or more interference RS resources; monitoring one or more interference RSs via the one or more interference RS resources corresponding to the one or more interference RS resource groups; and for each of the interference RS resource groups, determining at least one reception beam based at least in part on each of the monitored one or more interference RS resources corresponding to at least one of the one or more interference RS resource groups; receiving control signaling, from the wireless node, indicating quasi-colocation (QCL) information, wherein the QCL information indicates either to refrain from using any monitored interference RS resource group in the reference signal resource configuration in determining spatial reception parameters or identify at least one monitored interference RS resource group in the reference signal resource configuration to use in determining the spatial reception parameters; and determining the spatial reception parameters in accordance with the control signaling.

Example 107. A computer readable medium having instructions stored thereon for: transmitting, to a wireless node, a reference signal resource configuration indicating one or more interference reference signal (RS) resources associated with interference reference signal transmissions; receiving, from the wireless node, a beam interference report indicating one or more interference levels of a reception beam at the wireless node based at least in part on the one or more interference RS resources; transmitting control signaling, to the wireless node, indicating quasi-colocation (QCL) information, wherein the QCL information indicates to either refrain from using any interference RS resource in the reference signal resource configuration in determining spatial reception parameters or identify at least one interference RS resource in the reference signal resource configuration to use in determining the spatial reception parameters; and scheduling full duplex communications involving the wireless node and one or more other wireless nodes based at least in part on the beam interference report.

Example 108. A computer readable medium having instructions stored thereon for: transmitting, to a wireless node, a reference signal resource configuration indicating one or more interference reference signal (RS) resource groups associated with interference RS transmissions, wherein each of the interference RS resource groups comprises one or more interference RS resources; receiving, from the wireless node, a beam interference report indicating one or more interference levels of a reception beam at the wireless node based at least in part on the one or more interference RS resource groups; transmitting control signaling, to the wireless node, indicating quasi-colocation (QCL) information, wherein the QCL information indicates either to refrain from using any monitored interference RS resource group in the reference signal resource configuration in determining spatial reception parameters or identify at least one monitored interference RS resource group in the reference signal resource configuration to use in determining the spatial reception parameters; and scheduling full duplex communications involving the wireless node and one or more other wireless nodes based at least in part on the beam interference report.

Example 109. A method for wireless communication by a first wireless node, comprising: receiving, from a second wireless node, a reference signal (RS) resource configuration indicating one or more interference RS resources; monitoring one or more interference RSs for each of the one or more interference RS resources, wherein the one or more interference RSs for each of the one or more interference RS resources are associated with a plurality of transmission beams; measuring, for the one or more interference RSs of each of the one or more interference RS resources, interference associated with at least one of the plurality of beams; generating an interference report based on the measurement; and transmitting the interference report to the second wireless node.

Example 110. The method of example 109, wherein the interference report indicates one or more preferred beams of the plurality of transmission beams associated with a number of the one or more interference RS resources by at least one of: one or more beam indices associated with the one or more preferred beams for each of the number of the one or more interference RS resources; or one or more interference RS resource indices associated with each of the number of the one or more interference RS resources corresponding to the one or more preferred beams.

Example 111. The method of example 110, wherein the interference report further indicates the one or more preferred beams for the number of the one or more interference RS resources by: indicating an interference level associated with each of the one or more preferred beams of the plurality of transmission beams for the number of the one or more interference RS resources.

Example 112. The method of example 110, further comprising: determining at least one of a quantity of the preferred beams for the number of the one or more interference RS resources, or the quantity of the number of the one or more interference RS resources, wherein the determination is in accordance with at least one of the RS resource configuration or as predefined in a standard or determined by the TIE without further configuration or predefinition.

Example 113. The method of example 110, wherein, at least one of: a quantity of preferred beams of the plurality of transmission beams for each of the number of the one or more interference RS resources equals or is less than the quantity of the associated plurality of beams, or is only one; or the quantity of the number of the one or more interference RS resources equals or is less than the quantity of the one or more interference RS resources, or is only one.

Example 114. The method of one of examples 110-113, further comprising determining the one or more preferred beam based on reducing interference associated with the monitored one or more interference RS resources, wherein the interference associated with one beam of the plurality of transmission beams is identified based at least in part on the interference RS associated with the beam.

Example 115. The method of example 109, wherein: the RS resource configuration further indicates to perform averaging of the interference over a plurality of monitoring occasions; and generating the interference report indicates the average of the interference over the plurality of monitoring occasions in accordance with the RS resource configuration.

Example 116. The method according to any of the preceding examples, wherein: the RS resource configuration further indicates to perform the monitoring of the one or more interference RS resources on a semi-persistent, periodic, aperiodic, or dynamic basis; and the one or more interference RSs are monitored on the semi-persistent, periodic, aperiodic, or dynamic basis as indicated by the RS resource configuration.

Example 117. The method of one of examples 109-115, wherein: the RS resource configuration further indicates one or more channel state information reference signal (CSI-RS) resources, wherein each of the one or more CSI-RS resources is associated with at least one of the one or more interference RS resources; and the method further comprises: monitoring at least one CSI-RS via each of the one or more CSI-RS resources; and measuring a receive signal parameter associated with the at least one CSI-RS for each of the one or more CSI-RS resources, the interference report indicating the receive signal parameter associated with the at least one CSI-RS for each of the one or more CSI-RS resources.

Example 118. The method of example 117, wherein the interference report indicates one or more CSI-RS indices associated with the one or more interference RS resources.

Example 119. The method of example 117, wherein the one or more CSI-RS resources comprises at least one non-zero power CSI-RS resource.

Example 120. The method of example 117, wherein the one or more interference RS resources comprises a plurality of interference RS resources associated with the same CSI-RS resource.

Example 121. The method of example 117, wherein each the one or more interference RS resources is associated with a different one of the one or more CSI-RS resources.

Example 122. The method of example 117, wherein the one or more interference RS resources comprises one or more other CSI-RS resources, the one or more other CSI-RS resources being different from the one or more CSI-RS resources.

Example 123. The method of one of examples 117-122, further comprising determining the one or more preferred beam based on reducing interference associated with the monitored one or more interference RS resources, wherein the interference associated with one beam of the plurality of transmission beams is identified based at least in part on the interference RS associated with the beam and a corresponding CSI-RS resource of the one or more CSI-RS resources.

Example 124. The method of example 117, further comprising calculating a signal-to-interference-plus-noise ratio (SINR) associated with at least one of the one or more interference RS resources, wherein: an interference parameter of the SINR calculation corresponds to the interference associated with the at least one of the one or more interference RS resources; a signal parameter of the SINR calculation is the receive signal parameter associated with a respective CSI-RS resource of the one or more CSI-RS resources; and the interference report indicates the SINR associated with the at least one of the one or more interference RS resources.

Example 125. The method of one of the examples 109-124, wherein: the one or more interference RS resources comprises one or more full-duplex interference resources; the RS resource configuration further indicates one or more half-duplex interference RS resources; the method further comprises: monitoring the one or more interference RSs via each of the one or more half-duplex interference RS resources; and measuring another interference associated with each beam of the plurality of transmission beams for the one or more interference RSs of each of the one or more half-duplex interference RSs resources, the interference report being generated further based on the measured other interference.

Example 126. The method of one of examples 109-124, wherein the one or more interference RS resources are sounding reference signal (SRS) resources.

Example 127. The method of one of examples 109-124, wherein the first wireless node is a user equipment (UE), and wherein the second wireless node is a base station.

Example 128. The method of one of examples 109-122, wherein the first wireless node is a child node, and wherein the second wireless node is a donor node.

Example 129. A method for wireless communication by a first wireless node, comprising: receiving, from a second wireless node, a reference signal (RS) resource configuration indicating one or more interference RS resource groups; monitoring one or more interference RSs for each of the one or more interference RS resource groups, wherein the one or more interference RSs for each of the one or more interference RS resource groups are associated with a plurality of transmission beams; measuring, for the one or more interference RSs of each of the one or more interference RS resource groups, interference associated with at least one of the plurality of beams; generating an interference report based on the measurement; and transmitting the interference report to the second wireless node.

Example 130. The method of example 129, wherein the interference report indicates one or more preferred beams of the plurality of transmission beams associated with a number of the one or more interference RS resource groups by at least one of: one or more beam indices associated with the one or more preferred beams for each of the number of the one or more interference RS resource groups; or one or more interference RS resource indices associated with each of the number of the one or more interference RS resource groups corresponding to the one or more preferred beams.

Example 131. The method of example 130, wherein the interference report further indicates the one or more preferred beams for the number of the one or more interference RS resource groups by: indicating an interference level associated with each of the one or more preferred beams of the plurality of transmission beams for the number of the one or more interference RS resource groups.

Example 132. The method of example 130, further comprising: determining at least one of a quantity of the preferred beams for the number of the one or more interference RS resource groups, or the quantity of the number of the one or more interference RS resource groups, wherein the determination is in accordance with at least one of the RS resource configuration or as predefined in a standard or determined by the UE without further configuration or predefinition.

Example 133. The method of example 130, wherein, at least one of: a quantity of preferred beams of the plurality of transmission beams for each of the number of the one or more interference RS resource groups equals or is less than the quantity of the associated plurality of beams, or is only one; or the quantity of the number of the one or more interference RS resource groups equals or is less than the quantity of the one or more interference RS resource groups, or is only one.

Example 134. The method of one of examples 130-133, further comprising determining the one or more preferred beam based on reducing interference associated with the monitored one or more interference RS resource groups, wherein the interference associated with one beam of the plurality of transmission beams is identified based at least in part on the interference RS associated with the beam.

Example 135. The method of example 129, wherein: the RS resource configuration further indicates to perform averaging of the interference over a plurality of monitoring occasions; and generating the interference report indicates the average of the interference over the plurality of monitoring occasions in accordance with the RS resource configuration.

Example 136. The method according to any of the preceding examples, wherein: the RS resource configuration further indicates to perform the monitoring of the one or more interference RS resource groups on a semi-persistent, periodic, aperiodic, or dynamic basis; and the one or more interference RSs are monitored on the semi-persistent, periodic, aperiodic, or dynamic basis as indicated by the RS resource configuration.

Example 137. The method of one of examples 129-136, wherein: the RS resource configuration further indicates one or more channel state information reference signal (CSI-RS) resources, wherein each of the one or more CSI-RS resources is associated with at least one of the one or more interference RS resource groups; and the method further comprises: monitoring at least one CSI-RS via each of the one or more CSI-RS resource groups; and measuring a receive signal parameter associated with the at least one CSI-RS for each of the one or more CSI-RS resources, the interference report indicating the receive signal parameter associated with the at least one CSI-RS for each of the one or more CSI-RS resources.

Example 138. The method of example 137, wherein the interference report indicates one or more CSI-RS indices associated with the one or more interference RS resource groups.

Example 139. The method of example 137, wherein the one or more CSI-RS resources comprises at least one non-zero power CSI-RS resource.

Example 140. The method of example 137, wherein the one or more interference RS resource groups comprises a plurality of interference RS resource groups associated with the same CSI-RS resource.

Example 141. The method of example 137, wherein each the one or more interference RS resource groups is associated with a different one of the one or more CSI-RS resources.

Example 142. The method of example 137, wherein the one or more interference RS resource groups comprises one or more other CSI-RS resources, the one or more other CSI-RS resources being different from the one or more CSI-RS resources.

Example 143. The method of one of examples 137-142, further comprising determining the one or more preferred beam based on reducing interference associated with the monitored one or more interference RS resource groups, wherein the interference associated with one beam of the plurality of transmission beams is identified based at least in part on the interference RS associated with the beam and a corresponding CSI-RS resource of the one or more CSI-RS resources.

Example 144. The method of example 137, further comprising calculating a signal-to-interference-plus-noise ratio (SINR) associated with at least one of the one or more interference RS resource groups, wherein: an interference parameter of the SINR calculation corresponds to the interference associated with the at least one of the one or more interference RS resource groups; a signal parameter of the SINR calculation is the receive signal parameter associated with a respective CSI-RS resource of the one or more CSI-RS resources; and the interference report indicates the SINR associated with the at least one of the one or more interference RS resource groups.

Example 145. The method of one of the examples 129-144, wherein: the one or more interference RS resource groups comprises one or more full-duplex interference resources; the RS resource configuration further indicates one or more half-duplex interference RS resources; the method further comprises: monitoring the one or more interference RSs via each of the one or more half-duplex interference RS resources; and measuring another interference associated with each beam of the plurality of transmission beams for the one or more interference RSs of each of the one or more half-duplex interference RSs resources, the interference report being generated further based on the measured other interference.

Example 146. The method of one of examples 129-144, wherein the one or more interference RS resource groups are sounding reference signal (SRS) resource groups.

Example 147. The method of one of examples 129-144, wherein the first wireless node is a user equipment (UE), and wherein the second wireless node is a base station.

Example 148. The method of one of examples 129-142, wherein the first wireless node is a child node, and wherein the second wireless node is a donor node.

Example 149. A method for wireless communication by a first wireless node, comprising: receiving, from a second wireless node, a reference signal (RS) resource configuration indicating one or more interference RS resources; monitoring for one or more interference RSs via the one or more interference RS resources; determining, for each of the one or more interference RS resources, a reception beam based on the one or more interference RSs of the one or more interference RS resources, wherein the reception beam is one of a plurality of reception beams used to receive the one or more interference RSs, the reception beam having the lowest reception power of the plurality of reception beams; selecting a transmission beam corresponding to the reception beam; and transmitting signaling to the second wireless node via the transmission beam.

Example 150. The method of example 149, wherein the first wireless node is a user equipment (TIE), and wherein the second wireless node is a base station.

Example 151. The method of example 149, wherein the first wireless node is a child node, and wherein the second wireless node is a donor node.

Example 152. A method for wireless communication by a first wireless node, comprising: receiving, from a second wireless node, a reference signal (RS) resource configuration indicating one or more full-duplex interference RS resources and one or more half-duplex interference RS resources; transmitting one or more interference RSs for each of the one or more full-duplex interference RS resources and the one or more half-duplex interference resources; receiving, from the second wireless node, an indication of quasi-colocation (QCL) information after the transmission of the one or more interference RSs, the QCL information indicating first spatial relation information to use for transmissions via the one or more full-duplex interference resources and second spatial relation information to use for transmission via one or more half-duplex interference resources; and transmitting signaling to the second wireless node in accordance with the QCL information.

Example 153. The method of example 152, wherein the indication of QCL information is in accordance with first spatial relation information for a UE-specific physical uplink control channel (PUCCH) transmission and is composed by radio resource control (RRC), medium access control-control element (MAC-CE), or downlink control information (DCI); or the indication of QCL information is in accordance with second spatial relation information for a UE-specific physical uplink shared channel (PUSCH) transmission and is composed by RRC, MAC-CE, or DCI.

Example 154. The method of example 153, wherein: the interference RS resources are SRS resources, and the QCL information indicating the first and the second spatial information is comprised of a respective one of a first SRS resource indicator and a second SRS resource indicator.

Example 155. The method of example 152, wherein the first wireless node is a user equipment (UE), and wherein the second wireless node is a base station.

Example 156. The method of example 152, wherein the first wireless node is a child node, and wherein the second wireless node is a donor node.

Example 157. A method of wireless communication by a first wireless node, comprising: transmitting, to a second wireless node, a reference signal (RS) resource configuration indicating one or more interference RS resources to be monitored, wherein one or more interference RSs for each of the one or more interference RS resources are associated with a plurality of transmission beams; receiving an interference report indicating, for the one or more interference RSs of each of the one or more interference RS resources, interference associated with at least one of the plurality of transmission beams; and scheduling full duplex communication involving the second wireless node and one or more other wireless nodes based at least in part on the interference report.

Example 158. The method of example 157, wherein the interference report indicates one or more preferred beams of the plurality of transmission beams associated with a number of the one or more interference RS resources by at least one of: one or more beam indices associated with the one or more preferred beams for each of the number of the one or more interference RS resources; or one or more interference RS resource indices associated with each of the number of the one or more interference RS resources corresponding to the one or more preferred beams.

Example 159. The method of example 158, wherein the interference report further indicates the one or more preferred beams for the number of the one or more interference RS resources by: indicating an interference level associated with each of the one or more preferred beams of the plurality of transmission beams for the number of the one or more interference RS resources.

Example 160. The method of example 158, further comprising: determining at least one of a quantity of the preferred beams for the number of the one or more interference RS resources, or the quantity of the number of the one or more interference RS resources, wherein the determination is in accordance with at least one of the RS resource configuration or as predefined in a standard.

Example 161. The method of example 158, wherein, at least one of: a quantity of preferred beams of the plurality of transmission beams for each of the number of the one or more interference RS resources equals or is less than the quantity of the associated plurality of beams, or is only one; or the quantity of the number of the one or more interference RS resources equals or is less than the quantity of the one or more interference RS resources, or is only one.

Example 162. The method of one of examples 158, 159, 160, 161, further comprising determining the one or more preferred beam based on reducing interference associated with the monitored one or more interference RS resources, wherein the interference associated with one beam of the plurality of transmission beams is identified based at least in part on the interference RS associated with the beam.

Example 163. The method of example 157, further comprising transmitting, to one of the one or more other wireless nodes, another RS resource configuration indicating the one or more interference RS resources for transmission of the one or more interference RSs for the one or more interference RS resources via the plurality of transmission beams.

Example 164. The method of example 157, wherein: the one or more interference RS resources comprises one or more full-duplex interference resources; the RS resource configuration further indicates one or more half-duplex interference RS resources; and the interference report further indicates another interference associated with each beam of the plurality of transmission beams for the one or more interference RSs of each of the one or more half-duplex interference RS resources.

Example 165. The method of example 164, further comprising: transmitting, to the one of the other wireless nodes, an indication of quasi-colocation (QCL) information after the transmission of the one or more interference RSs, the QCL information indicating first spatial relation information to use for transmissions via the one or more full-duplex interference resources and second spatial relation information to use for transmission via one or more half-duplex interference resources; and receiving signaling from the one of the other wireless nodes in accordance with the QCL information.

Example 166. The method of example 165, wherein the indication of QCL information is in accordance with first spatial relation information for a UE-specific physical uplink control channel (PUCCH) transmission and is composed by radio resource control (RRC), medium access control-control element (MAC-CE), or downlink control information (DCI); or the indication of QCL information is in accordance with second spatial relation information for a UE-specific physical uplink shared channel (PUSCH) transmission and is composed by RRC, MAC-CE, or DCI.

Example 167. The method of example 165, wherein the one or more interference RS resources are SRS resources, and the QCL information indicating the first and the second spatial information is comprised of a respective one of a first SRS resource indicator and a second SRS resource indicator.

Example 168. The method of example 157, wherein the RS resource configuration further indicates to perform averaging of the interference over a plurality of monitoring occasions, the interference report indicating the average of the interference over the plurality of monitoring occasions.

Example 169. The method of example 157, wherein: the RS resource configuration further indicates one or more channel state information reference signal (CSI-RS) resources to be monitored, wherein each of the one or more CSI-RS resources is associated with at least one of the one or more interference RS resources; the method further comprises transmitting at least one CSI-RS via each of the one or more CSI-RS resources; and the interference report indicates a receive signal parameter associated with the at least one CSI-RS for each of the one or more CSI-RS resources.

Example 170. The method of example 169, wherein the interference report indicates one or more CSI-RS indices associated with the one or more interference RS resources.

Example 171. The method of example 169, wherein the one or more CSI-RS resources comprises at least one non-zero power CSI-RS resource.

Example 172. The method of example 169, wherein the one or more interference RS resources comprises a plurality of interference RS resources associated with the same CSI-RS resource.

Example 173. The method of example 169, wherein each the one or more interference RS resources is associated with a different one of the one or more CSI-RS resources.

Example 174. The method of example 169, wherein the one or more interference RS resources comprises one or more other CSI-RS resources, the one or more other CSI-RS resources being different from the one or more CSI-RS resources.

Example 175. The method of example 169, wherein the interference report indicates a signal-to-interference-plus-noise ratio (SINR) associated with at least one of the one or more interference RS resources, wherein: an interference parameter of the SINR corresponds to the interference associated with the at least one of the one or more interference RS resources; and a signal parameter of the SINR corresponds to the receive signal parameter associated with a respective CSI-RS resource of the one or more CSI-RS resources.

Example 176. The method of example 157, wherein the RS resource configuration further indicates to monitor the one or more interference RS resources on a semi-persistent, periodic, aperiodic, or dynamic basis.

Example 177. The method of example 157, wherein the first wireless node is a base station, and wherein the second wireless node is a user-equipment (UE).

Example 178. The method of example 157, wherein the first wireless node is a donor node, and wherein the second wireless node is a child node.

Example 179. A method of wireless communication by a first wireless node, comprising: transmitting, to a second wireless node, a reference signal (RS) resource configuration indicating one or more interference RS resource groups to be monitored, wherein one or more interference RSs for each of the one or more interference RS resource groups are associated with a plurality of transmission beams; receiving an interference report indicating, for the one or more interference RSs of each of the one or more interference RS resource groups, interference associated with at least one of the plurality of transmission beams; and scheduling full duplex communication involving the second wireless node and one or more other wireless nodes based at least in part on the interference report.

Example 180. The method of example 179, wherein the interference report indicates one or more preferred beams of the plurality of transmission beams associated with a number of the one or more interference RS resource groups by at least one of: one or more beam indices associated with the one or more preferred beams for each of the number of the one or more interference RS resource groups; or one or more interference RS resource indices associated with each of the number of the one or more interference RS resource groups corresponding to the one or more preferred beams.

Example 181. The method of example 180, wherein the interference report further indicates the one or more preferred beams for the number of the one or more interference RS resource groups by: indicating an interference level associated with each of the one or more preferred beams of the plurality of transmission beams for the number of the one or more interference RS resource groups.

Example 182. The method of example 180, further comprising: determining at least one of a quantity of the preferred beams for the number of the one or more interference RS resource groups, or the quantity of the number of the one or more interference RS resource groups, wherein the determination is in accordance with at least one of the RS resource configuration or as predefined in a standard.

Example 183. The method of example 180, wherein, at least one of: a quantity of preferred beams of the plurality of transmission beams for each of the number of the one or more interference RS resource groups equals or is less than the quantity of the associated plurality of beams, or is only one; or the quantity of the number of the one or more interference RS resource groups equals or is less than the quantity of the one or more interference RS resource groups, or is only one.

Example 184. The method of one of examples 180, 181, 182, 183, further comprising determining the one or more preferred beam based on reducing interference associated with the monitored one or more interference RS resource groups, wherein the interference associated with one beam of the plurality of transmission beams is identified based at least in part on the interference RS associated with the beam.

Example 185. The method of example 179, further comprising transmitting, to one of the one or more other wireless nodes, another RS resource configuration indicating the one or more interference RS resource groups for transmission of the one or more interference RSs for the one or more interference RS resource groups via the plurality of transmission beams.

Example 186. The method of one of example 184, wherein: the one or more interference RS resource groups comprises one or more full-duplex interference resources; the RS resource configuration further indicates one or more half-duplex interference RS resources; and the interference report further indicates another interference associated with each beam of the plurality of transmission beams for the one or more interference RSs of each of the one or more half-duplex interference RS resources.

Example 187. The method of example 186, further comprising: transmitting, to the one of the other wireless nodes, an indication of quasi-colocation (QCL) information after the transmission of the one or more interference RSs, the QCL information indicating first spatial relation information to use for transmissions via the one or more full-duplex interference resources and second spatial relation information to use for transmission via one or more half-duplex interference resources; and receiving signaling from the one of the other wireless nodes in accordance with the QCL information.

Example 188. The method of example 187, wherein the indication of QCL information is in accordance with first spatial relation information for a UE-specific physical uplink control channel (PUCCH) transmission and is composed by radio resource control (RRC), medium access control-control element (MAC-CE), or downlink control information (DCI); or the indication of QCL information is in accordance with second spatial relation information for a UE-specific physical uplink shared channel (PUSCH) transmission and is composed by RRC, MAC-CE, or DCI.

Example 189. The method of example 187, wherein: the one or more interference RS resource groups are SRS resource groups, and the QCL information indicating the first and the second spatial information is comprised of a respective one of a first SRS resource indicator and a second SRS resource indicator.

Example 190. The method of example 179, wherein the RS resource configuration further indicates to perform averaging of the interference over a plurality of monitoring occasions, the interference report indicating the average of the interference over the plurality of monitoring occasions.

Example 191. The method of example 179, wherein: the RS resource configuration further indicates one or more channel state information reference signal (CSI-RS) resources to be monitored, wherein each of the one or more CSI-RS resources is associated with at least one of the one or more interference RS resource groups; the method further comprises transmitting at least one CSI-RS via each of the one or more CSI-RS resources; and the interference report indicates a receive signal parameter associated with the at least one CSI-RS for each of the one or more CSI-RS resources.

Example 192. The method of example 191, wherein the interference report indicates one or more CSI-RS indices associated with the one or more interference RS resource groups.

Example 193. The method of example 191, wherein the one or more CSI-RS resources comprises at least one non-zero power CSI-RS resource.

Example 194. The method of example 191, wherein the one or more interference RS resource groups comprises a plurality of interference RS resource groups associated with the same CSI-RS resource.

Example 195. The method of example 191, wherein each the one or more interference RS resource groups is associated with a different one of the one or more CSI-RS resources.

Example 196. The method of example 191, wherein the one or more interference RS resource groups comprises one or more other CSI-RS resource groups, the one or more other CSI-RS resource groups being different from the one or more CSI-RS resources.

Example 197. The method of example 191, wherein the interference report indicates a signal-to-interference-plus-noise ratio (SINR) associated with at least one of the one or more interference RS resource groups, wherein: an interference parameter of the SINR corresponds to the interference associated with the at least one of the one or more interference RS resource groups; and a signal parameter of the SINR corresponds to the receive signal parameter associated with a respective CSI-RS resource of the one or more CSI-RS resources.

Example 198. The method of example 179, wherein the RS resource configuration further indicates to monitor the one or more interference RS resource groups on a semi-persistent, periodic, aperiodic, or dynamic basis.

Example 199. The method of example 179, wherein the first wireless node is a base station, and wherein the second wireless node is a user-equipment (UE).

Example 200. The method of example 179, wherein the first wireless node is a donor node, and wherein the second wireless node is a child node.

Example 201. An apparatus for wireless communication by a first wireless node, comprising: a receiver configured to receive, from a second wireless node, a reference signal (RS) resource configuration indicating one or more interference RS resources; a processing system configured to: monitor one or more interference RSs for each of the one or more interference RS resources, wherein the one or more interference RSs for each of the one or more interference RS resources are associated with a plurality of transmission beams; measure, for the one or more interference RSs of each of the one or more interference RS resources, interference associated with at least one of the plurality of beams; and generate an interference report based on the measurement; and a transmitter configured to transmit the interference report to the second wireless node.

Example 202. An apparatus for wireless communication by a first wireless node, comprising: a receiver configured to receive, from a second wireless node, a reference signal (RS) resource configuration indicating one or more interference RS resource groups; a processing system configured to: monitor one or more interference RSs for each of the one or more interference RS resource groups, wherein the one or more interference RSs for each of the one or more interference RS resource groups are associated with a plurality of transmission beams; measure, for the one or more interference RSs of each of the one or more interference RS resource groups, interference associated with at least one of the plurality of beams; and generate an interference report based on the measurement; and a transmitter configured to transmit the interference report to the second wireless node.

Example 203. An apparatus for wireless communication by a first wireless node, comprising: a receiver configured to receive, from a second wireless node, a reference signal (RS) resource configuration indicating one or more interference RS resources; a processing system configured to: monitor for one or more interference RSs via the one or more interference RS resources; determine, for each of the one or more interference RS resources, a reception beam based on the one or more interference RSs of the one or more interference RS resources, wherein the reception beam is one of a plurality of reception beams used to receive the one or more interference RSs, the reception beam having the lowest reception power of the plurality of reception beams; and select a transmission beam corresponding to the reception beam; and a transmitter configured to transmit signaling to the second wireless node via the transmission beam.

Example 204. An apparatus for wireless communication by a first wireless node, comprising: a receiver configured to receive, from a second wireless node, a reference signal (RS) resource configuration indicating one or more full-duplex interference RS resources and one or more half-duplex interference RS resources; a transmitter configured to transmit one or more interference RSs for each of the one or more full-duplex interference RS resources and the one or more half-duplex interference resources, wherein: the receiver is further configured to receive, from the second wireless node, an indication of quasi-colocation (QCL) information after the transmission of the one or more interference RSs, the QCL information indicating first spatial relation information to use for transmissions via the one or more full-duplex interference resources and second spatial relation information to use for transmission via one or more half-duplex interference resources; and the transmitter is further configured to transmit signaling to the second wireless node in accordance with the QCL information.

Example 205. An apparatus for wireless communication by a first wireless node, comprising: a transmitter configured to transmit, to a second wireless node, a reference signal (RS) resource configuration indicating one or more interference RS resources to be monitored, wherein one or more interference RSs for each of the one or more interference RS resources are associated with a plurality of transmission beams; a receiver configured to receive an interference report indicating, for the one or more interference RSs of each of the one or more interference RS resources, interference associated with at least one of the plurality of transmission beams; and a processing system configured to schedule full duplex communication involving the second wireless node and one or more other wireless nodes based at least in part on the interference report.

Example 206. An apparatus for wireless communication by a first wireless node, comprising: a transmitter configured to transmit, to a second wireless node, a reference signal (RS) resource configuration indicating one or more interference RS resource groups to be monitored, wherein one or more interference RSs for each of the one or more interference RS resource groups are associated with a plurality of transmission beams; a receiver configured to receive an interference report indicating, for the one or more interference RSs of each of the one or more interference RS resource groups, interference associated with at least one of the plurality of transmission beams; and a processing system configured to schedule full duplex communication involving the second wireless node and one or more other wireless nodes based at least in part on the interference report.

Example 207. An apparatus for wireless communication by a first wireless node, comprising: means for receiving, from a second wireless node, a reference signal (RS) resource configuration indicating one or more interference RS resources; means for monitoring one or more interference RSs for each of the one or more interference RS resources, wherein the one or more interference RSs for each of the one or more interference RS resources are associated with a plurality of transmission beams; means for measuring, for the one or more interference RSs of each of the one or more interference RS resources, interference associated with at least one of the plurality of beams; means for generating an interference report based on the measurement; and means for transmitting the interference report to the second wireless node.

Example 208. An apparatus for wireless communication by a first wireless node, comprising: means for receiving, from a second wireless node, a reference signal (RS) resource configuration indicating one or more interference RS resource groups; means for monitoring one or more interference RSs for each of the one or more interference RS resource groups, wherein the one or more interference RSs for each of the one or more interference RS resource groups are associated with a plurality of transmission beams; means for measuring, for the one or more interference RSs of each of the one or more interference RS resource groups, interference associated with at least one of the plurality of beams; means for generating an interference report based on the measurement; and means for transmitting the interference report to the second wireless node.

Example 209. An apparatus for wireless communication by a first wireless node, comprising: means for receiving, from a second wireless node, a reference signal (RS) resource configuration indicating one or more interference RS resources; means for monitoring for one or more interference RSs via the one or more interference RS resources; means for determining, for each of the one or more interference RS resources, a reception beam based on the one or more interference RSs of the one or more interference RS resources, wherein the reception beam is one of a plurality of reception beams used to receive the one or more interference RSs, the reception beam having the lowest reception power of the plurality of reception beams; means for selecting a transmission beam corresponding to the reception beam; and means for transmitting signaling to the second wireless node via the transmission beam.

Example 210. An apparatus for wireless communication by a first wireless node, comprising: means for receiving, from a second wireless node, a reference signal (RS) resource configuration indicating one or more full-duplex interference RS resources and one or more half-duplex interference RS resources; means for transmitting one or more interference RSs for each of the one or more full-duplex interference RS resources and the one or more half-duplex interference resources; means for receiving, from the second wireless node, an indication of quasi-colocation (QCL) information after the transmission of the one or more interference RSs, the QCL information indicating first spatial relation information to use for transmissions via the one or more full-duplex interference resources and second spatial relation information to use for transmission via one or more half-duplex interference resources; and means for transmitting signaling to the second wireless node in accordance with the QCL information.

Example 211. An apparatus for wireless communication by a first wireless node, comprising: means for transmitting, to a second wireless node, a reference signal (RS) resource configuration indicating one or more interference RS resources to be monitored, wherein one or more interference RSs for each of the one or more interference RS resources are associated with a plurality of transmission beams; means for receiving an interference report indicating, for the one or more interference RSs of each of the one or more interference RS resources, interference associated with at least one of the plurality of transmission beams; and means for scheduling full duplex communication involving the second wireless node and one or more other wireless nodes based at least in part on the interference report.

Example 212. An apparatus for wireless communication by a first wireless node, comprising: means for transmitting, to a second wireless node, a reference signal (RS) resource configuration indicating one or more interference RS resource groups to be monitored, wherein one or more interference RSs for each of the one or more interference RS resource groups are associated with a plurality of transmission beams; means for receiving an interference report indicating, for the one or more interference RSs of each of the one or more interference RS resource groups, interference associated with at least one of the plurality of transmission beams; and means for scheduling full duplex communication involving the second wireless node and one or more other wireless nodes based at least in part on the interference report.

Example 213. A computer-readable medium having instructions stored thereon to cause a first wireless node to: receive, from a second wireless node, a reference signal (RS) resource configuration indicating one or more interference RS resources; monitor one or more interference RSs for each of the one or more interference RS resources, wherein the one or more interference RSs for each of the one or more interference RS resources are associated with a plurality of transmission beams; measure, for the one or more interference RSs of each of the one or more interference RS resources, interference associated with at least one of the plurality of beams; generate an interference report based on the measurement; and transmit the interference report to the second wireless node.

Example 214. A computer-readable medium having instructions stored thereon to cause a first wireless node to: receive, from a second wireless node, a reference signal (RS) resource configuration indicating one or more interference RS resource groups; monitor one or more interference RSs for each of the one or more interference RS resource groups, wherein the one or more interference RSs for each of the one or more interference RS resource groups are associated with a plurality of transmission beams; measure, for the one or more interference RSs of each of the one or more interference RS resource groups, interference associated with at least one of the plurality of beams; generate an interference report based on the measurement; and transmit the interference report to the second wireless node.

Example 215. A computer-readable medium having instructions stored thereon to cause a first wireless node to: receive, from a second wireless node, a reference signal (RS) resource configuration indicating one or more interference RS resources; monitor for one or more interference RSs via the one or more interference RS resources; determine, for each of the one or more interference RS resources, a reception beam based on the one or more interference RSs of the one or more interference RS resources, wherein the reception beam is one of a plurality of reception beams used to receive the one or more interference RSs, the reception beam having the lowest reception power of the plurality of reception beams; select a transmission beam corresponding to the reception beam; and transmit signaling to the second wireless node via the transmission beam.

Example 216. A computer-readable medium having instructions stored thereon to cause a first wireless node to: receive, from a second wireless node, a reference signal (RS) resource configuration indicating one or more full-duplex interference RS resources and one or more half-duplex interference RS resources; transmit one or more interference RSs for each of the one or more full-duplex interference RS resources and the one or more half-duplex interference resources; receive, from the second wireless node, an indication of quasi-colocation (QCL) information after the transmission of the one or more interference RSs, the QCL information indicating first spatial relation information to use for transmissions via the one or more full-duplex interference resources and second spatial relation information to use for transmission via one or more half-duplex interference resources; and transmit signaling to the second wireless node in accordance with the QCL information.

Example 217. A computer-readable medium having instructions stored thereon to cause a first wireless node to: transmit, to a second wireless node, a reference signal (RS) resource configuration indicating one or more interference RS resources to be monitored, wherein one or more interference RSs for each of the one or more interference RS resources are associated with a plurality of transmission beams; receive an interference report indicating, for the one or more interference RSs of each of the one or more interference RS resources, interference associated with at least one of the plurality of transmission beams; and schedule full duplex communication involving the second wireless node and one or more other wireless nodes based at least in part on the interference report.

Example 218. A computer-readable medium having instructions stored thereon to cause a first wireless node to: transmit, to a second wireless node, a reference signal (RS) resource configuration indicating one or more interference RS resource groups to be monitored, wherein one or more interference RSs for each of the one or more interference RS resource groups are associated with a plurality of transmission beams; receive an interference report indicating, for the one or more interference RSs of each of the one or more interference RS resource groups, interference associated with at least one of the plurality of transmission beams; and schedule full duplex communication involving the second wireless node and one or more other wireless nodes based at least in part on the interference report.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably.

A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2).

The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

A BS may be a station that communicates with user equipment (UEs). Each BS may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. In some examples, a cell may not necessarily be stationary, and the geographic area of the cell may move according to the location of a mobile BS. In some examples, the BSs may be interconnected to one another and/or to one or more other BSs or network nodes in a wireless communication network through various types of backhaul interfaces, such as a direct physical connection, a wireless connection, a virtual network, or the like using any suitable transport network.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A wireless communication network may be a heterogeneous network that includes BSs of different types, e.g., macro BS, pico BS, femto BS, relays, etc. These different types of BSs may have different transmit power levels, different coverage areas, and different impact on interference in the wireless communication network. For example, macro BS may have a high transmit power level (e.g., 20 Watts) whereas pico BS, femto BS, and relays may have a lower transmit power level (e.g., 1 Watt).

A wireless communication network may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (e.g., 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe. In NR, a subframe is still 1 ms, but the basic TTI is referred to as a slot. A subframe contains a variable number of slots (e.g., 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing.

NR may utilize OFDM with a CP on the uplink and downlink and include support for half-duplex operation using TDD. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 7-11, 13-15, and 17-21.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
a receiver configured to:
receive, from a wireless node, a reference signal resource configuration indicating one or more first interference reference signal (RS) resources associated with interference reference signal transmissions or one or more interference RS resource groups associated with the interference reference signal transmissions, wherein each of the interference RS resource groups comprises one or more second interference RS resources, and
receive control signaling, from the wireless node, indicating quasi-colocation (QCL) information, wherein the QCL information indicates to either refrain from using any monitored interference RS resource in the reference signal resource configuration in determining spatial reception parameters or identify at least one monitored interference RS resource in the reference signal resource configuration to use in determining the spatial reception parameters; and
a processing system configured to:
monitor one or more interference RSs via the one or more first interference RS resources or the one or more second interference RS resources,
determine, for each of the one or more first interference RS resources or each of the interference RS resource groups, at least one reception beam based at least in part on each of the monitored one or more interference RSs corresponding to at least one of the one or more first interference RS resources or the one or more second interference RS resources, and
determine the spatial reception parameters in accordance with the control signaling.

2. The apparatus of claim 1, wherein:
the processing system is configured to determine the at least one reception beam based on reducing interference associated with the monitored one or more first interference RS resources or the monitored one or more interference RS resource groups.

3. The apparatus of claim 1, wherein:
the processing system is configured to generate a beam interference report including interference levels of the at least one reception beam based at least in part on the monitored one or more first interference RS resources or the monitored one or more interference RS resource groups; and
the apparatus further comprises a transmitter configured to transmit, to the wireless node, the beam interference report.

4. The apparatus of claim 1, wherein:
the reference signal resource configuration further indicates a number of interference RS repetitions over time associated with each of the one or more first interference RS resources or each of the one or more interference RS resource groups; and
all of the interference RS repetitions associated with one of the one or more interference RS resources correspond to a same transmission beam.

5. The apparatus of claim 3, wherein:
the reference signal resource configuration further indicates one or more channel state information reference signal (CSI-RS) resources associated with CSI-RS transmissions from the wireless node, wherein each of the one or more CSI-RS resources is associated with at least one of the one or more first interference RS resources or the one or more interference RS resource groups, and wherein the one or more CSI-RS resources includes at least one non-zero power CSI-RS resource;
the processing system is configured to:
monitor one or more CSI-RSs from the wireless node via the one or more CSI-RS resources, and
generate the beam interference report based at least in part on the monitored one or more CSI-RSs.

6. The apparatus of claim 3, wherein the beam interference report indicates one or more interference levels associated with at least one of the monitored one or more first interference RS resources, the monitored one or more interference RS resource groups, or the one or more CSI-RS resources.

7. The apparatus of claim 1, wherein the one or more first interference RS resources are sounding reference signal (SRS) resources or CSI-RS resources that are different from the one or more CSI-RS resources transmitted by the wireless node, or wherein the one or more interference RS resource groups include SRS resources or CSI-RS resources that are different from the one or more CSI-RS resources transmitted by the wireless node.

8. The apparatus of claim 1, wherein:
the control signaling further indicates at least one interference RS resource for the QCL information; and
the processing system is configured to identify at least one interference RS resource from an indication of a transmission configuration indicator (TCI) state with the QCL information included in the control signaling.

9. The apparatus of claim 1, wherein:
the control signaling refrains from indicating any monitored interference RS resource for the QCL information; and
the processing system is configured to identify that an indication of a TCI state with the QCL information refrains from indicating any monitored interference RS for the QCL information in the control signaling, wherein the processing system is configured to:
identify explicitly from a monitored interference RS resource identifier included in the control signaling; or
identify implicitly using a monitored CSI-RS, transmitted by the wireless node, that is associated with one of the monitored one or more first interference RS resources or the monitored one or more interference RS resource groups.

10. The apparatus of claim 1, wherein the apparatus is a user equipment or a child node, and the wireless node is a base station or a donor node.

11. An apparatus for wireless communication, comprising:
a receiver configured to receive, from a wireless node, a reference signal (RS) resource configuration indicating one or more interference RS resources or one or more interference RS resource groups;
a processing system configured to:
monitor one or more interference RSs for each of the one or more interference RS resources or for each of the one or more interference RS resource groups, wherein the one or more interference RSs for each of the one or more interference RS resources or for each of the one or more interference RS resource groups are associated with a plurality of transmission beams,
measure, for the one or more interference RSs of each of the one or more interference RS resources or each of the one or more interference RS resource groups, interference associated with at least one of the plurality of beams, and
generate an interference report based on the measurement; and
a transmitter configured to transmit the interference report to the wireless node.

12. The apparatus of claim 11, wherein the interference report indicates one or more preferred beams of the plurality of transmission beams associated with a number of the one or more interference RS resources or the one or more interference RS resource groups by at least one of:
one or more beam indices associated with the one or more preferred beams for each of the number of the one or more interference RS resources or the one or more interference RS resource groups; or
one or more interference RS resource indices associated with each of the number of the one or more interference RS resources or the one or more interference RS resource groups corresponding to the one or more preferred beams.

13. The apparatus of claim 12, wherein the processing system is configured to determine at least one of a quantity of the preferred beams for the number of the one or more interference RS resources or the one or more interference RS resource groups, or the quantity of the number of the one or more interference RS resources or the one or more interference RS resource groups, wherein the determination is in accordance with at least one of the RS resource configuration or as predefined in a standard or determined by the apparatus without further configuration or predefinition.

14. The apparatus of claim 12, wherein, at least one of:
a quantity of preferred beams of the plurality of transmission beams for each of the number of the one or more interference RS resources or the one or more interference RS resource groups equals or is less than the quantity of the associated plurality of beams, or is only one; or
the quantity of the number of the one or more interference RS resources or the one or more interference RS resource groups equals or is less than the quantity of the one or more interference RS resources or the one or more interference RS resource groups, or is only one.

15. The apparatus of claim 12, wherein the processing system is configured to determine the one or more preferred beam based on reducing interference associated with the monitored one or more interference RS resources, wherein the interference associated with one beam of the plurality of transmission beams is identified based at least in part on the interference RS associated with the beam.

16. The apparatus of claim 11, wherein:
the RS resource configuration further indicates one or more channel state information reference signal (CSI-RS) resources, wherein each of the one or more CSI-RS resources is associated with at least one of the one or more interference RS resources or the one or more interference RS resource groups, wherein the one or more CSI-RS resources comprises at least one non-zero power CSI-RS resource; and
the processing system is configured to:
monitor at least one CSI-RS via each of the one or more CSI-RS resources; and
measure a receive signal parameter associated with the at least one CSI-RS for each of the one or more CSI-RS resources, the interference report indicating the receive signal parameter associated with the at least one CSI-RS for each of the one or more CSI-RS resources.

17. The apparatus of claim 16, wherein the processing system is configured to calculate a signal-to-interference-plus-noise ratio (SINR) associated with at least one of the one or more interference RS resources or the one or more interference RS resource groups, wherein:
an interference parameter of the SINR calculation corresponds to the interference associated with the at least one of the one or more interference RS resources or the one or more interference RS resource groups;
a signal parameter of the SINR calculation is the receive signal parameter associated with a respective CSI-RS resource of the one or more CSI-RS resources; and
the interference report indicates the SINR associated with the at least one of the one or more interference RS resources or the one or more interference RS resource groups.

18. The apparatus of claim 11, wherein:
the one or more interference RS resources or the one or more interference RS resource groups comprises one or more full-duplex interference resources;
the RS resource configuration further indicates one or more half-duplex interference RS resources;
the processing system is configured to:
monitor the one or more interference RSs via each of the one or more half-duplex interference RS resources; and
measure another interference associated with each beam of the plurality of transmission beams for the one or more interference RSs of each of the one or more half-duplex interference RSs resources, the interference report being generated further based on the measured other interference.

19. The apparatus of claim 11, wherein the one or more interference RS resources are sounding reference signal (SRS) resources, or wherein the one or more interference RS resource groups are sounding reference signal (SRS) resource groups.

20. The apparatus of claim 11, wherein the apparatus is a user equipment (UE) or a child node, and wherein the wireless node is a base station or a donor node.

21. An apparatus for wireless communication, comprising:
a receiver configured to receive, from a wireless node, a reference signal (RS) resource configuration indicating one or more interference RS resources;
a processing system configured to:
monitor for one or more interference RSs via the one or more interference RS resources,
determine, for each of the one or more interference RS resources, a reception beam based on the one or more interference RSs of the one or more interference RS resources, wherein the reception beam is one of a plurality of reception beams used to receive the one or more interference RSs, the reception beam having the lowest reception power of the plurality of reception beams, and
select a transmission beam corresponding to the reception beam; and
a transmitter configured to transmit signaling to the wireless node via the transmission beam.

22. The apparatus of claim 21, wherein the apparatus is a user equipment (UE) or a child node, and wherein the wireless node is a base station or a donor node.

23. An apparatus for wireless communication, comprising:
a receiver configured to receive, from a wireless node, a reference signal (RS) resource configuration indicating one or more full-duplex interference RS resources and one or more half-duplex interference RS resources;
a transmitter configured to transmit one or more interference RSs for each of the one or more full-duplex interference RS resources and the one or more half-duplex interference resources, wherein:
the receiver is further configured to receive, from the wireless node, an indication of quasi-colocation (QCL) information after the transmission of the one or more interference RSs, the QCL information indicating first spatial relation information to use for transmissions via the one or more full-duplex interference resources and second spatial relation information to use for transmission via one or more half-duplex interference resources; and
the transmitter is further configured to transmit signaling to the wireless node in accordance with the QCL information.

24. The apparatus of claim 23, wherein
the indication of QCL information is in accordance with first spatial relation information for a UE-specific physical uplink control channel (PUCCH) transmission and is composed by radio resource control (RRC), medium access control-control element (MAC-CE), or downlink control information (DCI); or
the indication of QCL information is in accordance with second spatial relation information for a UE-specific physical uplink shared channel (PUSCH) transmission and is composed by RRC, MAC-CE, or DCI.

25. The apparatus of claim 24, wherein:
the interference RS resources are SRS resources, and the QCL information indicating the first and the second spatial information is comprised of a respective one of a first SRS resource indicator and a second SRS resource indicator.

26. The apparatus of claim 23, wherein the apparatus is a user equipment (UE) or a child node, and wherein the wireless node is a base station or a donor node.
